(19) United States
(12) Patent Application Publication
(10) Pub. No.: US 2025/0190454 A1
(43) Pub. Date: Jun. 12, 2025

(54) PROMPT-BASED DATA STRUCTURE AND DOCUMENT RETRIEVAL

(71) Applicant: Pienomial Inc., Rockville, MD (US)

(72) Inventors: Omkar K. Patil, Pune (IN); Sanat Mohanty, Rockville, MD (US)

(21) Appl. No.: 18/972,759

(22) Filed: Dec. 6, 2024

Related U.S. Application Data
(60) Provisional application No. 63/607,714, filed on Dec. 8, 2023.
(60) Provisional application No. 63/721,389, filed on Nov. 15, 2024.

(51) Int. Cl. G06F 16/332; G06F 16/3332; G06F 16/355

(52) U.S. Cl. CPC G06F 16/3326; G06F 16/3332; G06F 16/355

(57) ABSTRACT

A knowledge management system may generate a plurality of prompts based on divisions of documents of unstructured text, each prompt relevant to a division of unstructured text. At least one prompt is generated such that a corresponding division of unstructured text is a response to said at least one prompt. The system may generate prompt embeddings for the plurality of prompts corresponding to the plurality of documents of unstructured text. The system may generate prompt-embedding clusters to group similar prompts from one or more documents of unstructured text. The system may receive a query. The system may convert the query to one or more query embeddings. The system may identify one or more prompts that are relevant to the query based on comparing the one or more query embeddings to the prompt embeddings. The system may identify one or more documents in one or more prompt-embedding clusters.

### CROSS REFERENCE TO RELATED APPLICATIONS

This application claims the benefit of U.S. Provisional Application No. 63/607,714, filed on Dec. 8, 2023, and U.S. Provisional Application No. 63/721,389, filed on Nov. 15, 2024. The contents of those applications are incorporated by reference herein in their entirety for all purposes.

### BACKGROUND

In many industries, the rapid growth of unstructured data has presented significant challenges for information management, retrieval, and analysis. Unstructured data, such as textual content found in research articles, technical documents, and legal filings, lacks an inherent organization that facilitates efficient querying or processing. Conventional systems often rely on keyword-based searches or manual curation, which can be time-consuming, imprecise, and computationally expensive, particularly for large datasets.

Advances in machine learning and natural language processing (NLP) have enabled new methods for analyzing and organizing unstructured data. For example, language models can process text to extract semantic meaning, identify relationships among entities, and generate embeddings that represent textual data in a structured format. These techniques, while powerful, still face limitations in scalability, accuracy, and computational efficiency when applied to large-scale datasets or complex queries. Furthermore, the ability to contextualize and cluster related information for efficient retrieval remains a challenge.

Retrieving relevant information from large sets of unstructured data can be particularly time-intensive due to the vast volume and dispersed nature of the information. Systems must process massive datasets to identify and rank results, often leading to delays that hinder real-time decision-making. Additionally, language models used for retrieval and summarization can exhibit hallucination, generating information that appears plausible but is inaccurate or entirely fabricated. This issue undermines trust in the results and necessitates improved mechanisms to ensure that extracted information is both accurate and relevant to the query. As the demand for robust and efficient retrieval systems grows, solutions that address these challenges are increasingly critical.

### BRIEF DESCRIPTION OF THE DRAWINGS

Figure (FIG.) 1 is a block diagram of an example system environment, in accordance with some embodiments.

FIG. 2 is a block diagram illustrating various components of an example knowledge management system, in accordance with some embodiments.

FIG. 3 is a flowchart illustrating a process for generating a knowledge graph and responding to a query based on the knowledge graph, in accordance with some embodiments.

FIG. 4A is a graphical illustration of the entity identification process in the node generation stage, in accordance with some embodiments.

FIG. 4B illustrates a result of entity extraction from an unstructured text, in accordance with some embodiments.

FIG. 4C is a graphical illustration of a node and graph fusion process, in accordance with some embodiments.

FIG. 4D is a conceptual illustration of a large knowledge graph, in accordance with some embodiments.

FIG. 5 is a flowchart depicting an example process for performing prompt-based documents retrieval to improve the retrieval speed and accuracy of documents, in accordance with some embodiments.

FIG. 6A is a conceptual diagram illustrating an example graphical user interface that is part of a platform provided by the knowledge management system, in accordance with some embodiments.

FIG. 6B is a conceptual diagram illustrating an example graphical user interface that is part of a platform provided by the knowledge management system, in accordance with some embodiments.

FIG. 7A is a conceptual diagram illustrating an example graphical user interface that is part of a platform provided by the knowledge management system, in accordance with some embodiments.

FIG. 7B is a conceptual diagram illustrating an example graphical user interface that is part of a platform provided by the knowledge management system, in accordance with some embodiments.

FIG. 8 is conceptual diagram illustrating an example neural network, in accordance with some embodiments.

FIG. 9 is a block diagram illustrating components of an example computing machine, in accordance with some embodiments.

The figures depict, and the detailed description describes, various non-limiting embodiments for purposes of illustration only.

### DETAILED DESCRIPTION

The figures (FIGs.) and the following description relate to preferred embodiments by way of illustration only. One of skill in the art may recognize alternative embodiments of the structures and methods disclosed herein as viable alternatives that may be employed without departing from the principles of what is disclosed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

The disclosure is related to systems for improving the retrieval speed and accuracy of information from large corpora of unstructured text. A knowledge management system may use a structured approach to transform unstructured documents into a queryable format. For example, the knowledge management system may generate prompts (e.g., contextually relevant questions) based on divisions of unstructured documents, such as paragraphs or sections. Each prompt is designed to correspond to specific content in the text.

The knowledge management system may employ a language model such as an encoder-only model to generate embedding vectors that represent the semantic and contextual meaning of the prompts in a high-dimensional space. These embeddings are clustered to group similar prompts, forming prompt-embedding clusters that encapsulate shared themes or topics. The knowledge management system may further these clusters, such as subdividing large clusters into smaller, more precise groupings. The prompts may be stored as entities that are further stored in a knowledge graph.

When a user query is received, the query may be converted into query embeddings that are compared against the stored prompt embeddings. The process may identify the most relevant prompts and the associated clusters, narrowing down the scope to specific documents or sections. The knowledge management system may generate a knowledge graph as a data structure to store the relationships among prompts, documents, and other entities. The knowledge graph enables queries to retrieve not only direct answers but also insights into interconnected concepts, providing flexibility for complex data exploration. The knowledge management system may handle vast datasets efficiently, making it highly suitable for domains such as life sciences, regulatory research, and legal document analysis.

### System Overview

Referring now to Figure (FIG.) 1, shown is a block diagram illustrating an embodiment of an example system environment 100 for data integration and processing, in accordance with some embodiments. By way of example, the system environment 100 includes a knowledge management system 110, data sources 120, client devices 130, an application 132, a user interface 134, a domain 135, a data store 140, and a model serving system 145. The entities and components in the system environment 100 may communicate with each other through network 150. In various embodiments, the system environment 100 may include fewer or additional components. The system environment 100 also may include different components.

The components in the system environment 100 may each correspond to a separate and independent entity or may be controlled by the same entity. For example, in some embodiments, the knowledge management system 110 and an application 132 are operated by the same entity. In some embodiments, the knowledge management system 110 and a model serving system 145 can be operated by different entities.

While each of the components in this disclosure is sometimes described in disclosure in a singular form, the system environment 100 and elsewhere in this disclosure may include one or more of each of the components. For example, there can be multiple client devices 130 that are in communication with the knowledge management system 110. The knowledge management system 110 may also collect data from multiple data sources 120. Likewise, while some of the components are described in a plural form, in some embodiments each of those components may have only a single instance in the system environment 100.

In some embodiments, the knowledge management system 110 integrates knowledge from multiple sources, including research papers, Wikipedia entries, articles, databases, technical documentations, books, legal and regulatory documents, other educational content, and additional data sources such as news articles, social media content, patents and technical documentation. The knowledge management system 110 may also access public databases such as the National Institutes of Health (NIH) repositories, the European Molecular Biology Laboratory (EMBL) database, and the Protein Data Bank (PDB), etc. The knowledge management system 110 employs an architecture that ingests unstructured data, identifies entities in the data, and constructs a knowledge graph that connects various entities. The knowledge graph may include nodes and relationships among the entities to facilitate efficient retrieval.

An entity is any object of potential attention in data. Entities may include a wide range of concepts, data points, named entities, and other entities relevant to a domain of interest. For example, in the domain interest of drug discovery or life science, entities may include medical conditions such as myocardial infarction, sclerosis, diabetes, hypertension, asthma, rheumatoid arthritis, epilepsy, depression, chronic kidney disease, Alzheimer's disease, Parkinson's disease, and psoriasis. Entities may also include any pharmaceutical drugs, such as Ziposia, Aspirin, Metformin, Ibuprofen, Lisinopril, Atorvastatin, Albuterol, Omeprazole, Warfarin, and Amoxicillin. Biomarkers, including inflammatory markers or genetic mutations, are also common entities. Additionally, entities may encompass molecular pathways, such as apoptotic pathways or metabolic cascades. Clinical trial phases, such as Phase I, II, or III trials, may also be identified as entities, alongside adverse events like transient ischemic attacks or cardiac arrhythmias. Furthermore, entities may represent therapeutic interventions, such as radiotherapy or immunotherapy, statistical measures like objective response rates or toxicity levels, and organizations, such as regulatory bodies like the U.S. Food and Drug Administration (FDA) or research institutions. Entities may also include data categories, such as structured data, unstructured text, or vectors, as well as user queries, such as “What are the side effects of [drug]?” or “List all trials for [disease].”

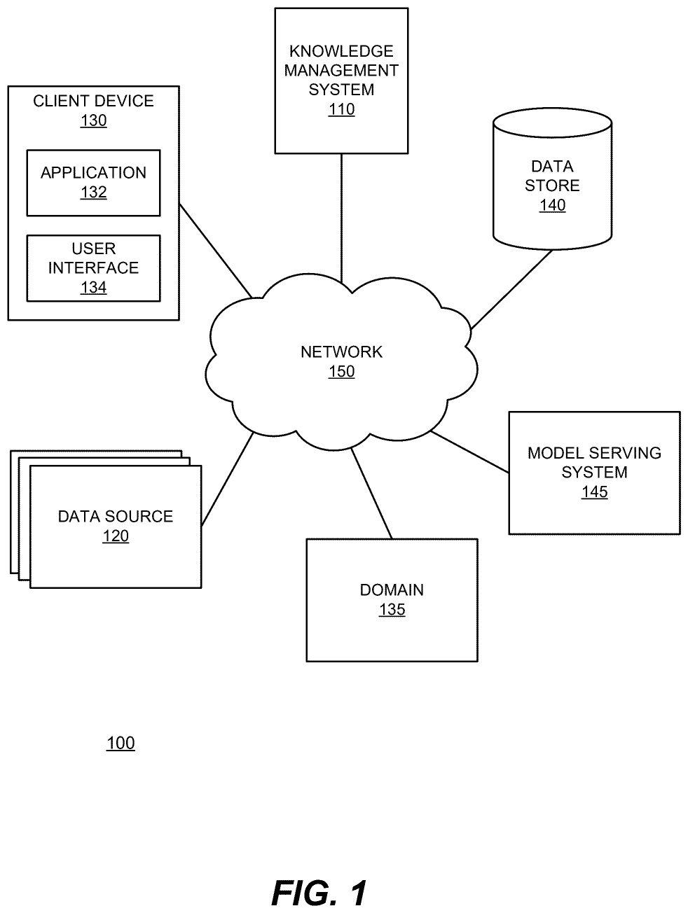

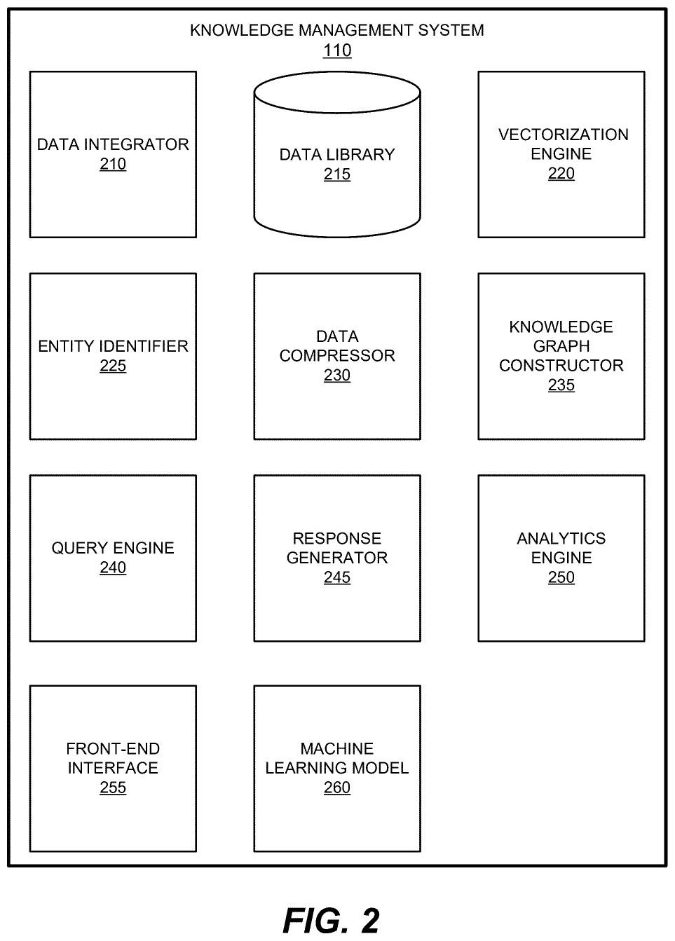

In some embodiments, entities may be extracted from papers and articles, such as research articles, including those indexed in PubMed, ArVix, Nature, Science, The Lancet, and other specific journal references, and other data sources such as clinical trial documents from the FDA. For example, in a unstructured text of a sentence from a research paper, “The study demonstrated that patients with chronic obstructive pulmonary disease (COPD) treated with Salbutamol showed significant improvement in forced expiratory volume (FEV1) after 12 weeks of therapy.” In some embodiments, entities in the sentence include “chronic obstructive pulmonary disease,” “COPD,” “Salbutamol,” “forced expiratory volume,” “FEV1,” and “12 weeks.” Abbreviations may first be identified as separate entities but later fused with the entities that represent the long form. Non-entities include terms and phrases such as “the study,” “that,” “with,” “showed,” and “after.” Detail of how the knowledge management system 110 extracts entities from articles will be further discussed in association with FIG. 2. The identities of the articles and authors may also be recorded as entities.

While the examples of knowledge, articles and entities are primarily described in the life science context, the knowledge management system 110 may also manage knowledge in other domains of interest, such as financial analytics, environmental science, materials engineering, and other suitable natural science, social science, and/or engineering fields. In some embodiments, the knowledge management system 110 may also create a knowledge graph of the world knowledge that may include multi-disciplinary domains of knowledge. A set of documents (e.g., articles, papers, documents) that are used to construct a knowledge graph may be referred to as a corpus.

In some embodiments, the entities extracted and managed by the knowledge management system 110 may also be multi-modal, which include entities from text, graphs, images, videos, audios, and other data types. In some embodiments, the entities extracted and managed by the knowledge management system 110 may also be multi-modal, which include entities from text, images, videos, audios, and other data types. Entities extracted from images may include visual features such as molecular structures, histopathological patterns, or annotated graphs in scientific diagrams. The knowledge management system 110 may employ computer vision techniques, such as convolutional neural networks (CNNs), to identify and classify relevant elements within an image, such as detecting specific cell types, tumor regions, or labeled points on a chart. In some embodiments, entities extracted from audio data may include spoken terms, numerical values, or instructions, such as dictated medical notes, research conference discussions, or audio annotations in a study. The knowledge management system 110 may utilize speech-to-text models, combined with entity recognition algorithms, to convert audio signals into structured data while identifying key terms or phrases.

In some embodiments, the knowledge management system 110 may construct a knowledge graph by representing entities as nodes and relationships among the entities as edges. Relationships may be determined in different ways, such as the semantic relationships among entities, proxies of entities appearing in an article (e.g., two entities appearing in the same paragraph or same sentence), transformer multi-head attention determination, co-occurrence of entities across multiple articles or datasets, citation references linking one entity to another, or direct annotations in structured databases. In some embodiments, relationships as edges may also include values that represent the strength of the relationships. For example, the strength of a relationship may be quantified based on the frequency of co-occurrence, cosine similarity of vector representations, statistical correlation derived from experimental data, or confidence scores assigned by a machine learning model. These values allow the knowledge graph to prioritize or rank connections, enabling nuanced analyses such as identifying the most influential entities within a specific domain or filtering weaker, less relevant relationships for focused querying and visualization. Detail of how a knowledge graph can be constructed will be further discussed.

In some embodiments, the knowledge management system 110 provides a query engine that allows users to provide prompts (e.g., questions) about various topics. The query engine may leverage both structured data and knowledge graphs to construct responses. Additionally, the knowledge management system 110 supports enhanced user interaction by automatically analyzing the context of user queries and generating related follow-up questions. For example, when a query pertains to a specific topic, the knowledge management system 110 might suggest supplementary questions to refine or deepen the query scope.

In some embodiments, the knowledge management system 110 deconstructs documents into discrete questions and identifies relevant questions for a given articles. This process involves breaking the text into logical segments, identifying key information, and formatting the segments as structured questions and responses. The questions identified may be stored as prompts that are relevant to a particular document. As such, each document may be associated with a set of prompts and a corpus of documents may be linked and organized by prompts (e.g., by questions). The prompt-driven data structure enhances the precision of subsequent searches and allows the knowledge management system 110 to retrieve specific and relevant sections instead of entire documents.

In some embodiments, the knowledge management system 110 may incorporate an advanced natural language processing (NLP) models such as language models for understanding and transforming data. The NLP model may be transformers that include encoders only, decoders only, or a combination and encoders and decoders, depending on the use case. In some embodiments, the knowledge management system 110 may support different modes of query execution, including probabilistic or deterministic retrieval methods. Probabilistic retrieval methods may prioritize articles and data segments based on calculated relevance scores, while deterministic methods may focus on explicit matches derived from a predefined structure.

In some embodiments, the knowledge management system 110 may incorporate dynamic visualization tools to represent relationships between extracted entities visually. The system may allow users to navigate through interconnected nodes in a knowledge graph to explore related concepts or data entities interactively. For instance, users could explore links between drugs, diseases, and molecular pathways within a medical knowledge graph.

In various embodiments, the knowledge management system 110 may take different suitable forms. For example, while the knowledge management system 110 is described in a singular form, the knowledge management system 110 may include one or more computers that operate independently, cooperatively, and/or distributively (i.e., in a distributed manner). The knowledge management system 110 may be operated by one or more computing devices. The one or more computing devices includes one or more processors and memory configured to store executive instructions. The instructions, when executed by the one or more processors, cause the one or more processors to perform omics data management processes that centrally manage the raw omics datasets received from the one or more data sources.

By way of examples, in various embodiments, the knowledge management system 110 may be a single server or a distributed system of servers that function collaboratively. In some embodiments, the knowledge management system 110 may be implemented as a cloud-based service, a local server, or a hybrid system in both local and cloud environments. In some embodiments, the knowledge management system 110 may be a server computer that includes one or more processors and memory that stores code instructions that are executed by one or more processors to perform various processes described herein. In some embodiments, the knowledge management system 110 may also be referred to as a computing device or a computing server. In some embodiments, the knowledge management system 110 may be a pool of computing devices that may be located at the same geographical location (e.g., a server room) or be distributed geographically (e.g., cloud computing, distributed computing, or in a virtual server network). In some embodiments, the knowledge management system 110 may be a collection of servers that independently, cooperatively, and/or distributively provide various products and services described in this disclosure. The knowledge management system 110 may also include one or more virtualization instances such as a container, a virtual machine, a virtual private server, a virtual kernel, or another suitable virtualization instance.

In some embodiments, data sources 120 include various repositories of textual and numerical information that are used for entity extraction, retrieval, and knowledge graph construction. The data sources 120 may include publicly accessible datasets, such as Wikipedia or PubMed, and proprietary datasets containing confidential or domain-specific information. A data source 120 may be a data source that contain research papers, including those indexed in PubMed, ArVix, Nature, Science, The Lancet, and other specific journal references, and other data sources such as clinical trial documents from the FDA. The datasets may be structured, semi-structured, or unstructured, encompassing formats such as articles in textual documents, JSON files, relational databases, or real-time data streams. The knowledge management system 110 may control one or more data sources 120 but may also use public data sources 120 and/or license documents from private data sources 120.

In some embodiments, the data sources 120 may incorporate multiple formats to accommodate diverse use cases. For instance, the data sources 120 may include full-text articles, abstracts, or curated datasets. These datasets may vary in granularity, ranging from detailed, sentence-level annotations to broader, document-level metadata. In some embodiments, the data sources 120 may support dynamic updates to ensure that the knowledge graph remains current. Real-time feeds from online databases or APIs can be incorporated into the data sources 120. In some embodiments, permissions and access controls may be applied to the data sources 120, restricting certain datasets to authorized users while maintaining public accessibility for others. In some embodiments, the knowledge management system 110 may be associated with a certain level of access privilege to a particular data source 120. In some embodiments, the access privilege may also be specific to a customer of the knowledge management system 110. For example, a customer may have access to some data sources 120 but not other data sources 120. In some embodiments, the data sources 120 may be extended with domain-specific augmentations. For example, in life sciences, data sources 120 may include ontologies describing molecular pathways, clinical trial datasets, and regulatory guidelines.

In some embodiments, various data sources 120 may be geographically distributed in different locations and manners. In some embodiments, data sources 120 may store data in public cloud providers, such as AMAZON WEB SERVICES (AWS), AZURE, and GOOGLE Cloud. The knowledge management system 110 may access and download data from data sources 120 on the Cloud. In some embodiments, a data source 120 may be a local server of the knowledge management system 110.

In some embodiments, a data source 120 may be provided by a client organization of the knowledge management system 110 and serve as the client specific data source that can be integrated with other public data sources 120. For example, a client specific knowledge graph can be generated and be integrated with a large knowledge graph maintained by the knowledge management system 110. As such, the client may have its own specific knowledge graph that may have element of specific domain ontology and the client may expand its research because the client specific knowledge graph portion is linked to a larger knowledge graph.

In some embodiments, the client device 130 is a user device that interacts with the knowledge management system 110. The client device 130 allows users to access, query, and interact with the knowledge management system 110 to retrieve, input, or analyze knowledge and information stored within the system. For example, a user may query the knowledge management system 110 to receive responses of prompts and extract specific entities, relationships or data points relevant to a particular topic of interest. Users may also upload new data, annotate existing information, or modify knowledge graph structures within the knowledge management system 110. Additionally, users can execute complex searches to explore relationships between entities, generate visualizations such as charts or graphs, or initiate simulations based on retrieved data. These capabilities enable users to utilize the knowledge management system 110 for tasks such as research, decision-making, drug discovery, clinical studies, or data analysis across various domains.

A client device 130 may be an electronic device controlled by a user who interacts with the knowledge management system 110. In some embodiments, a client device 130 may be any electronic device capable of processing and displaying data. These devices may include, but are not limited to, personal computers, laptops, smartphones, tablet devices, or smartwatches.

In some embodiments, an application 132 is a software application that serves as a client-facing frontend for the knowledge management system 110. An application 132 can provide a graphical or interactive interface through which users interact with the knowledge management system 110 to access, query, or modify stored information. An application 132 may offer features such as advanced search capabilities, data visualization, query builders and storage, or tools for annotating and editing knowledge and relationships. These features may allow users to efficiently navigate through complex datasets and extract meaningful insights. Users can interact with the application 132 to perform a wide range of tasks, such as submitting queries to retrieve specific data points or exploring relationships between knowledge. Additionally, users can upload new datasets, validate extracted entities, or customize data visualizations to suit the users' analytical needs. An application 132 may also facilitate the management of user accounts, permissions, and secure data access.

In some embodiments, a user interface 134 may be the interface of the application 132 and allow the user to perform various actions associated with application 132. For example, application 132 may be a software application, and the user interface 134 may be the front end. The user interface 134 may take different forms. In some embodiments, the user interface 134 is a graphical user interface (GUI) of a software application. In some embodiments, the front-end software application 132 is a software application that can be downloaded and installed on a client device 130 via, for example, an application store (App store) of the client device 130. In some embodiments, the front-end software application 132 takes the form of a webpage interface that allows users to perform actions through web browsers. A front-end software application includes a GUI 134 that displays various information and graphical elements. In some embodiments, the GUI may be the web interface of a software-as-a-service (SaaS) platform that is rendered by a web browser. In some embodiments, user interface 134 does not include graphical elements but communicates with a server or a node via other suitable ways, such as command windows or application program interfaces (APIs).

In some embodiments, the knowledge management system 110 may integrate public knowledge to domain knowledge specific to a particular domain 135. For example, a company client can request the knowledge management system 110 to integrate the client's domain knowledge to other knowledge available to the knowledge management system 110. A domain 135 refers to an environment for a group of units and individuals to operate and to use domain knowledge to organize activities, information and entities related to the domain 135 in a specific way. An example of a domain 135 is an organization, such as a pharmaceutical company, a biotech company, a business, a research institute, or a subpart thereof and the data within it. A domain 135 can be associated with a specific domain knowledge ontology, which could include representations, naming, definitions of categories, properties, logics, and relationships among various omics data that are related to the research projects conducted within the domain. The boundary of a domain 135 may not completely overlap with the boundary of an organization. For example, a domain may be a research team within a company. In other situations, various research groups and institutes may share the same domain 135 for conducting a collaborative project.

One or more data stores 140 may be used to store various data used in the system environment 100, such as various entities, entity representations, and knowledge graph. In some embodiments, data stores 140 may be integrated with the knowledge management system 110 to allow data flow between storage and analysis components. In some embodiments, the knowledge management system 110 may control one or more data stores 140.

A data store 140 includes one or more storage units, such as memory, that take the form of a non-transitory and non-volatile computer storage medium to store various data. The computer-readable storage medium is a medium that does not include a transitory medium, such as a propagating signal or a carrier wave. In one embodiment, the data store 140 communicates with other components by a network 150. This type of data store 140 may be referred to as a cloud storage server. Examples of cloud storage service providers may include AMAZON AWS, DROPBOX, RACKSPACE CLOUD FILES, AZURE, GOOGLE CLOUD STORAGE, etc. In some embodiments, instead of a cloud storage server, a data store 140 may be a storage device that is controlled and connected to a server, such as the knowledge management system 110. For example, the data store 140 may take the form of memory (e.g., hard drives, flash memory, discs, ROMs, etc.) used by the server, such as storage devices in a storage server room that is operated by the server. The data store 140 might also support various data storage architectures, including block storage, object storage, or file storage systems. Additionally, it may include features like redundancy, data replication, and automated backup to ensure data integrity and availability. A data store 140 can be a database, data warehouse, data lake, etc.

A model serving system 145 is a system that provides machine learning models. The model serving system 145 may receive requests from the knowledge management system 110 to perform tasks using machine learning models. The tasks may include, but are not limited to, natural language processing (NLP) tasks, audio processing tasks, image processing tasks, video processing tasks, etc. In some embodiments, the machine learning models deployed by the model serving system 145 are models that are originally trained to perform one or more NLP tasks but are fine-tuned for other specific tasks. The NLP tasks include, but are not limited to, text generation, context determination, query processing, machine translation, chatbots, and the like.

The machine learning models served by the model serving system 145 may take different model structures. In some embodiments, one or more models are configured to have a transformer neural network architecture. Specifically, the transformer model is coupled to receive sequential data tokenized into a sequence of input tokens and generates a sequence of output tokens depending on the task to be performed. Transformer models are examples of language models that may or may not be auto-regressive.

In some embodiments, the language models are large language models (LLMs) that are trained on a large corpus of training data to generate outputs. An LLM may be trained on massive amounts of training data, often involving billions of words or text units, and may be fine-tuned by domain specific training data. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters. In some embodiments, some of the language models used in this disclosure are smaller language models that are optimized for accuracy and speed.

Since an LLM has a significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a Cloud infrastructure service. The LLM may be pre-trained by the model serving system 145. In some embodiments, the LLM may also be fine-tuned by the model serving system 145 or by the knowledge management system 110.

In some embodiments, when the machine learning model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In one or more other embodiments, the transformer architecture may have an encoder-decoder architecture and includes a set of encoders coupled to a set of decoders. An encoder or decoder may include one or more attention operations. In some embodiments, the transformer models used by the knowledge management system 110 to encode entities are encoder only models. In some embodiments, a transformer model may include encoders only, decoders only, or a combination of encoders and decoders.

While an LLM with specific layer architecture is described as an example in this disclosure, the language model can be configured as any other appropriate architecture including, but not limited to, recurrent neural network (RNN), long short-term memory (LSTM) networks, Markov networks, Bidirectional Encoder Representations from Transformers (BERT), generative-adversarial networks (GAN), diffusion models (e.g., Diffusion-LM), linear RNN such as MAMBA, and the like. A machine learning model may be implemented using any suitable software package, such as PyTorch, TensorFlow, Mamba, Keras, etc.

In various embodiments, the model serving system 145 may or may not be operated by the knowledge management system 110. In some embodiments, the model serving system 145 is a sub-server or a sub-module of the knowledge management system 110 for hosting one or more machine learning models. In such cases, the knowledge management system 110 is considered to be hosting and operating one or more machine learning models. In some embodiments, a model serving system 145 is operated by a third party such as a model developer that provides access to one or more models through API access for inference and fine-tuning. For example, the model serving system 145 may be provided by a frontier model developer that trains a large language model that is available for the knowledge management system 110 to be fine-tuned to be used.

The communications among the knowledge management system 110, data sources 120, client device 130, application 132, data store 140, and the model serving system 145 may be transmitted via a network 150. In some situations, a network 150 may be a local network. In some situations, a network 150 may be a public network such as the Internet. In one embodiment, the network 150 uses standard communications technologies and/or protocols. Thus, the network 150 can include links using technologies such as Ethernet, 802.11, worldwide interoperability for microwave access (WiMAX), 3G, 4G, LTE, 5G, digital subscriber line (DSL), asynchronous transfer mode (ATM), InfiniBand, PCI Express Advanced Switching, etc. Similarly, the networking protocols used on the network 150 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 150 can be represented using technologies and/or formats, including the hypertext markup language (HTML), the extensible markup language (XML), etc. In addition, all or some of the links can be encrypted using conventional encryption technologies such as secure sockets layer (SSL), transport layer security (TLS), virtual private networks (VPNs), Internet Protocol security (IPsec), etc. The network 150 also includes links and packet-switching networks such as the Internet.

### Example Knowledge Management System

FIG. 2 is a block diagram illustrating various components of an example knowledge management system 110, in accordance with some embodiments. A knowledge management system 110 may include data integrator 210, data library 215, vectorization engine 220, entity identifier 225, data compressor engine 230, knowledge graph constructor 235, query engine 240, response generator 245, analytics engine 250, front-end interface 255, and machine learning model 260. In various embodiments, the knowledge management system 110 may include fewer or additional components. The knowledge management system 110 also may include different components. The functions of various components in knowledge management system 110 may be distributed in a different manner than described below. Moreover, while each of the components in FIG. 2 may be described in a singular form, the components may present in plurality.

In some embodiments, the data integrator 210 is configured to receive and integrate data from various data sources 120 into the knowledge management system 110. The data integrator 210 ingests structured, semi-structured, and unstructured data, including text, images, and numerical datasets. The data received may include research papers, clinical trial documents, technical specifications, and regulatory filings. For instance, the data sources 120 may comprise public databases like PubMed, private databases that knowledge management system 110 licenses, and proprietary datasets from client organizations. In some embodiments, the data integrator 210 employs various methods to parse and process the received data. For example, textual documents may be tokenized and segmented into manageable components such as paragraphs or sentences. Similarly, metadata associated with these documents, such as publication dates, authors, or research affiliations, is extracted and standardized.

In some embodiments, the data integrator 210 may support multiple formats and modalities of data. For instance, the received data may include textual documents in formats such as plain text, JSON, XML, and PDF. Images, such as diagrams, charts, or annotated medical images, may be provided in formats like PNG, JPEG, or TIFF. Numerical datasets may arrive in tabular formats, including CSV or Excel files. Audio data, such as recorded conference discussions, may also be processed through transcription systems. In some embodiments, the data integrator 210 may accommodate domain-specific data requirements by integrating specialized ontologies. For example, life sciences datasets may include structured ontologies describing molecular pathways, biomarkers, and clinical trial metadata. The data integrator 210 may also incorporate custom data parsing rules to handle these domain-specific data types effectively.

In some embodiments, the data library 215 stores and manages various types of data utilized by the knowledge management system 110. The data library 215 can be part of one or more data stores that store raw documents, tokenized entities, knowledge graphs, extracted prompts, and client prompt histories. Those kinds of data can be stored in a single data store or different data stores. The stored data may include unprocessed documents, processed metadata, and structured representations such as vectors and entity relationships.

In some embodiments, the data library 215 may support the storage of tokenized entities extracted from raw documents. These entities may include concepts such as diseases, drugs, molecular pathways, biomarkers, and clinical trial phases. The data library 215 may also manage knowledge graphs constructed from these entities, including relationships and metadata for subsequent querying and analysis. Additionally, the data library 215 may store client-specific prompts and the historical interactions associated with those prompts. This historical data allows the knowledge management system 110 to refine its retrieval and analysis processes based on user-specific preferences and past queries.

In some embodiments, the data library 215 may support multimodal data storage, enabling the integration of text, images, audio, and video data. For example, images such as molecular diagrams or histopathological slides may be stored alongside textual descriptions, while audio recordings of discussions may be transcribed and stored as searchable text. This multimodal capability allows the data library 215 to serve a wide range of domain-specific use cases, such as medical diagnostics or pharmaceutical research.

In some embodiments, the data library 215 may use a customized indexing and caching mechanisms to optimize data retrieval. In some embodiments, the entities in knowledge graphs may be represented as fingerprints that are N-bit integers (e.g., 32-bit, 64-bit, 128-bit, 256-bit). The fingerprints may be stored in a fast memory hardware such as the random-access memory (RAM) and the corresponding documents may be stored in hard drives such as solid state drives. This storage structure allows a knowledge graph and relationship among the entities to be stored in RAM and can be analyzed quickly. The knowledge management system 110 may then retrieve the underlying documents on demand from the hard drives.

The data can be stored in structured formats such as relational databases or unstructured data stores such as data lakes. In different embodiments, various data storage architectures may be used, like cloud-based storage, local servers, or hybrid systems, to ensure flexibility in data access and scalability. The data library 215 may include features for data redundancy, automated backup, and encryption to maintain data integrity and security. The data library 215 may take the form of a database, data warehouse, data lake, distributed storage system, cloud storage platform, file-based storage system, object storage, graph database, time-series database, or in-memory database, etc. The data library 215 allows the knowledge management system 110 to process large datasets efficiently while ensuring data reliability.

In some embodiments, the vectorization engine 220 is configured to convert natural-language text into embedding vectors, or simply referred to as embeddings. An embedding vector is a latent vector that represents text, mapped from the latent space of a neural network of a high-dimensional space (often exceeding 10 dimensions, such as 16 dimensions, 32 dimensions, 64 dimensions, 128 dimensions, or 256 dimensions). The embedding vector captures semantic and contextual information of the text, preserving relationships between words or phrases in a dense, compact format suitable for computational tasks. The vectorization engine 220 processes input text by analyzing its syntactic and semantic features. For instance, given a textual input such as “heart attack,” the vectorization engine 220 generates a multi-dimensional latent space that encodes contextual information, such as the text's association with medical conditions, treatments, or outcomes. For example, the embedding vector for “myocardial infarction” may closely align with that of “heart attack” in the high-dimensional space, reflecting the text's semantic relevancy. The embeddings can be used for a variety of downstream tasks, such as information retrieval, classification, clustering, and query generation.

In some embodiments, the vectorization engine 220 may generate embedding vectors using various methods and models. The vectorization engine 220 may use an encoder-only transformer that is trained by the knowledge management system 110. In some embodiments, the vectorization engine 220 may use Bidirectional Encoder Representations from Transformers (BERT), which process the input text to generate context-sensitive embedding vectors. Various transformer models may leverage self-attention mechanisms to understand relationships between words within a sentence or passage. Another method is Word2Vec, which generates word embeddings by analyzing large corpora of text to predict word co-occurrence, representing words as vectors in a latent space where semantically similar words are mapped closer together. Principal Component Analysis (PCA) may also be used to reduce the dimensionality of text features while retaining the most significant patterns, creating lower-dimensional embeddings useful for clustering or visualization. Semantic analysis models, such as Latent Semantic Analysis (LSA) or Latent Dirichlet Allocation (LDA), create embeddings by identifying latent topics or themes in text, which are then represented as vectors in a thematic space. Sentence embedding models, such as Sentence-BERT or Universal Sentence Encoder, produce sentence-level embeddings by capturing the overall semantic meaning of an entire sentence or paragraph. Text embeddings may also be derived from term frequency-inverse document frequency (TF-IDF) matrices, further refined using dimensionality reduction techniques like singular value decomposition (SVD). Neural networks designed for unsupervised learning, such as autoencoders, may also compress text representations into embeddings by encoding input text into a latent space and decoding the text to embeddings. The vectorization engine 220 may also support multi-modal embeddings, such as combining textual features with numerical or visual data to generate richer representations suitable for diverse applications. In some embodiments, the vectorization engine 220 may also encode images and audios into embeddings.

In some embodiments, the entity identifier 225 may receive embeddings from the vectorization engine 220 and determine whether the embeddings correspond to entities of interest within the knowledge management system 110. The embeddings represent data points or features derived from diverse datasets, including text, numerical records, or multi-modal content. The entity identifier 225 evaluates the embeddings using various classification techniques to determine whether the embeddings are entities or non-entities.

In some embodiments, the entity identifier 225 applies multi-target binary classification to assess embeddings. This method enables the simultaneous identification of multiple entities within a single dataset. For instance, when processing embeddings derived from a document, the entity identifier 225 may determine whether an entity candidate is one or more of a set of targets, such as drugs, diseases, biomarkers, or clinical outcomes. Each determination with respect to a target may be a binary classification (true or false). Hence, each entity candidate may be represented as a vector of binary values. The binary vector may be further analyzed such as by inputting the binary vectors of various entity candidates to a classifier (e.g., a neural network) to determine whether an entity candidate is in fact an entity. In some classifiers, the classifier may also determine the type of entity.

In some embodiments, the entity identifier 225 may also use language models (LLMs) to evaluate embeddings in context. For example, the entity identifier 225 may use transformer-based LLMs to assess whether an embedding aligns with known entities in predefined ontologies to determine whether an entity candidate is in fact an entity. This process may include interpreting relationships and co-occurrences within the original dataset to ensure accurate identification. The entity identifier 225 may also support iterative evaluation, refining entity assignments based on contextual cues and cross-referencing results with existing knowledge graphs. In some embodiments, the entity identifier 225 may integrate probabilistic methods alongside deterministic rules to account for uncertainty in entity classification. For example, embeddings with a high probability of matching multiple entity types may be flagged for manual review or additional processing. This hybrid approach ensures flexibility and robustness in managing ambiguous cases.

In some embodiments, the entity identifier 225 may support customizable classification rules tailored to specific domains. For example, in a pharmaceutical application, the entity identifier 225 may be configured to identify embeddings related to adverse events, therapeutic classes, or molecular interactions. Domain-specific ontologies can further enhance the classification process by providing context-sensitive criteria for identifying entities.

In some embodiments, the entity identifier 225 leverages embeddings from multiple language models, including both encoder-only models and encoder-decoder models. The embeddings may capture complementary perspectives on the data, enhancing the precision of entity identification. Additionally, the entity identifier 225 may utilize clustering techniques to group similar embeddings before classification to improve the classification.

In some embodiments, the data compressor 230 is configured to reduce the size and complexity of data representations within the knowledge management system 110 while retaining essential information for analysis and retrieval. The data compressor 230 processes embeddings and entities and uses various compression techniques to improve efficient storage, retrieval, and computation.

In some embodiments, the data compressor 230 may employ various compression techniques tailored to the nature of the data and the operational requirements. For instance, lossy compression techniques, such as quantization, may reduce embedding precision to smaller numerical ranges, enabling faster computation at the expense of slight accuracy reductions. In contrast, lossless methods, such as dictionary-based encoding, may retain exact values for applications requiring high fidelity. In some embodiments, embeddings may be compressed using clustering techniques, where similar embeddings are grouped together, and representative centroids replace individual embeddings.

In some embodiments, the data compressor 230 may implement compression schemes for multi-modal data. For example, embeddings derived from images, audio, or video can be compressed using convolutional or recurrent neural network architectures. These models create compact, domain-specific representations that integrate with embeddings from textual data, enabling cross-modal comparisons.

In some embodiments, the data compressor 230 is configured to receive a corpus of data, where the corpus may include a variety of data types, such as text, articles, images, audio recordings, or other suitable data formats. The data compressor 230 processes these entities by converting them into compact representations, referred to as entity fingerprints, that enable efficient storage and retrieval.

In some embodiments, the data compressor 230 aggregates the plurality of embedding vectors corresponding to entities into a reference vector. The reference vector may have the same dimensionality as each of the individual embedding vectors. Each embedding vector is then compared to the reference vector, value by value. Based on the comparison, the data compressor 230 assigns a Boolean value to each element in the embedding vector. For example, if the value of an element in the embedding vector exceeds the corresponding value in the reference vector, a Boolean value of “1” may be assigned; otherwise, a “0” may be assigned.

In some embodiments, the data compressor 230 converts each embedding vector into an entity Boolean vector based on the assigned Boolean values. Optionally, the entity Boolean vector may be further converted into an entity integer. The integer represents a compact numerical encoding of the Boolean vector. The resulting entity Boolean vector or entity integer is stored as an entity fingerprint. These fingerprints provide a compressed yet distinguishable representation for each entity in the corpus, facilitating efficient storage and retrieval operations.

In some embodiments, the knowledge graph constructor 235 is configured to generate a structured representation of entities and their relationships as a knowledge graph within the knowledge management system 110. The knowledge graph represents entities as nodes and their interconnections as edges, capturing semantic, syntactic, or contextual relationships between the entities. For example, entities such as “myocardial infarction” and “hypertension” might be linked based on their co-occurrence in medical literature or a direct causal relationship derived from clinical data.

In some embodiments, the knowledge graph constructor 235 constructs one or more knowledge graphs as a data structure of the entities extracted from unstructured text so that the corpus of unstructured text is connected in a data structure. The knowledge graph constructor 235 may derive relationships of entities, such as co-occurrence of entities in text, degree of proximity in the text (e.g., in the same sentence, in the same paragraph), explicit annotations in structured datasets, citation in the text, and statistical correlations from numerical data. The relationships may include diverse types, such as hierarchical, associative, or causal. For instance, relationships can indicate hierarchical inclusion (e.g., “disease” includes “cardiovascular disease”), co-occurrence (e.g., “clinical trial” and “drug A”), or interaction (e.g., “gene A” regulates “protein B”). The knowledge graph constructor 235 may also determine node assignment based on the type of entities, such as drugs, indications, diseases, biomarkers, or clinical outcomes. The node assignment may correspond to the targets in multi-target binary classification.

In some embodiments, the knowledge graph constructor 235 may also perform node fusion to consolidate duplicate or equivalent entities. For instance, if two datasets reference the same entity under different names, such as “multiple sclerosis” and “MS,” the knowledge graph constructor 235 identifies these entities as equivalent through multiple methodologies. The knowledge graph constructor 235 may use various suitable techniques to fuse entities, including direct text matching, where exact or normalized matches are identified, such as ignoring case sensitivity (e.g., “MS” and “ms”) or stripping irrelevant symbols (e.g., “multiple sclerosis” and “multiple-sclerosis”). The knowledge graph constructor 235 may also use embedding similarity where the knowledge graph constructor 235 evaluates the embedding proximity in a latent space using measures like cosine similarity. For example, embeddings for “MS,” “multiple sclerosis,” and related terms like “disseminated sclerosis” or “encephalomyelitis disseminata” would cluster closely. In some embodiments, the knowledge graph constructor 235 may employ domain-specific synonym dictionaries or ontologies to further refine the fusion process. For instance, a medical ontology might explicitly link “Transient Ischemic Attack” and “TIA,” or annotate abbreviations and full terms to facilitate accurate merging. The fusion process may also incorporate techniques like stripping irrelevant prefixes or suffixes, harmonizing abbreviations, or leveraging standardized data formats from domain-specific databases.

The knowledge graph constructor 235 may also analyze contextual data from source documents to confirm equivalence. For example, if two entities share identical relationships with surrounding nodes—such as being associated with the same drugs, biomarkers, or clinical trials—this relational context strengthens the likelihood of equivalence. In some embodiments, the knowledge graph constructor 235 applies multi-step refinement for node fusion. This may include probabilistic scoring, where potential matches are assigned confidence scores based on the strength of text similarity, embedding proximity, or co-occurrence frequency. In some embodiments, the matches exceeding a predefined threshold are fused. In some embodiments, the knowledge graph constructor 235 may also use a transformer language model to determine whether two entities should be fused.

In some embodiments, each document in a corpus may be converted into a knowledge graph and the knowledge graphs of various documents may be combined by fusing the same nodes. For example, two research articles may be related to different research, but both are related to an indication. The knowledge graph constructor 235 may merge the two knowledge graphs together through the node representing the indication. After multiple knowledge graphs are merged, an overall knowledge graph representing the knowledge of the corpus may be generated and stored as the data structure and relationships among the unstructured data in the corpus.

In some embodiments, the knowledge graph constructor 235 generates and stores the knowledge graph as a structured data format, such as JSON, RDF, or a graph database schema. Each node may represent an entity embedding and may contain attributes such as entity type, name, and source information. Edges may represent the relationships among the nodes and may be enriched with metadata, such as the type of relationship, frequency of interaction, or confidence scores. Each edge may also be associated with a value to represent the strength of relationship.

In some embodiments, the knowledge graph constructor 235 may extract questions from textual and structured data and transform the extracted questions into entities within the knowledge graph. The process involves parsing source documents, such as research papers, clinical trial records, or technical articles, and identifying logical segments of text that can be reformulated as discrete questions. For example, a passage discussing the side effects of a drug might yield a question like, “What are the side effects of [drug name]?” Similarly, descriptions of study results may produce questions such as, “What is the efficacy rate of [treatment] for [condition]?”

In some embodiments, the extraction of questions leverages language models, such as encoder-only or encoder-decoder transformers, to process textual data. The knowledge graph constructor 235 may use language models analyze text at the sentence or paragraph level, identify key information, and format the key information into structured questions. The questions may represent prompts or queries relevant to the associated document and may serve as bridges between unstructured data and structured query responses.

In some embodiments, the knowledge graph constructor 235 stores the extracted questions as entities in the knowledge graph. For example, a question entity like “What are the biomarkers for Alzheimer's disease?” may be linked to related entities, such as specific biomarkers, clinical trial phases, or research publications. In some embodiments, the knowledge graph constructor 235 clusters related questions into hierarchical or thematic groups in the knowledge graph. For instance, questions about “biomarkers” may form a cluster linked to higher-level topics such as “diagnostic tools” or “disease mechanisms.” This clustering facilitates efficient storage and retrieval, enabling users to navigate the knowledge graph through interconnected questions.

In some embodiments, the query engine 240 is configured to process user queries and retrieve relevant information from the knowledge graph stored within the knowledge management system 110. The query engine 240 interprets user inputs, formulates database queries, and executes these queries to return structured results. User inputs may range from natural language questions, such as “What are the approved treatments for multiple sclerosis?” to more complex analytical prompts, such as “Generate a bar chart of objective response rates for phase 2 clinical trials.”

Based on the knowledge graph, the query engine 240 locates specific nodes or edges relevant to the query. The query engine 240 may convert the user query (e.g., user prompt) into embedding and entities, using vectorization engine 220, entity identifier 225, and data compressor 230. In response to a user query for “drug efficacy,” the query engine 240 identifies nodes representing drugs and edges that denote relationships with efficacy metrics. Based on the entities identified in the query, the query engine 240 uses the knowledge graph to determine related entities in the knowledge graph. The searching of related entities may be based on the relationships and positions of nodes in the knowledge graph of a corpus. Alternatively, or additionally, the searching of related entities may also be based on the compressed fingerprints of the entities generated by the data compressor 230. For example, the query engine 240 may determine the Hamming distances between the entity fingerprints in the query and the entity fingerprints in the knowledge graph to identifies closely relevant entities. Alternatively, or additionally, the searching of related entities may also be based on the result of the analysis of a language model.

Upon identifying the relevant entities by the query engine 240 in response to a query, a response generator 245 may generate a response to the query. The response generator 245 processes the retrieved data and formats the data into output that is aligned with the query context. The response generated may take various forms, including natural language text, graphical visualizations, tabular data, or links to underlying documents.

In some embodiments, the response generator 245 utilizes a transformer-based model, such as a decoder-only language model, to generate a response. The response may be in the form of a natural-language text or may be in a structured format. For example, when the query pertains to drug efficacy rates for a specific treatment, the response generator 245 may retrieve relevant numerical data and format the data into a table. Similarly, if the query involves identifying relationships between diseases and molecular pathways, the response generator 245 may construct and present a graphical visualization illustrating the interconnected entities.

In some embodiments, the response generator 245 supports multi-modal outputs by integrating data from text, images, and metadata. For instance, the response generator 245 may include visual annotations on medical images or charts, provide direct links to sections of research papers, or generate textual summaries of retrieved data points. The response generator 245 also allows for customizable output formats, enabling users to specify the desired structure, such as bulleted lists, detailed reports, or concise summaries.

In some embodiments, the response generator 245 may leverage contextual understanding to adapt responses to the complexity and specificity of a query. For example, a query requesting a high-level overview of clinical trials may prompt the response generator 245 to produce a summarized textual response, while a more detailed query may lead to the generation of comprehensive tabular data including trial phases, participant demographics, and outcomes.

In some embodiments, the analytics engine 250 is configured to generate various forms of analytics based on data retrieved and processed by the knowledge management system 110. The analytics engine 250 uses the knowledge graph and integrated datasets to provide users with actionable insights, predictive simulations, and structured reports. These analytics may include descriptive, diagnostic, predictive, and prescriptive insights tailored to specific user queries or research goals.

In some embodiments, the analytics engine 250 performs advanced data analysis by leveraging machine learning models and statistical techniques. For example, the analytics engine 250 may predict outcomes such as drug efficacy or potential adverse effects by analyzing data trends within clinical trial results. Additionally, the analytics engine 250 supports hypothesis generation by identifying patterns and correlations within the data, such as biomarkers linked to therapeutic responses. For example, molecular data retrieved from the knowledge graph may be used to simulate toxicity profiles for new drug candidates. The results of such simulations may be fed back into the knowledge graph.

In some embodiments, the analytics engine 250 facilitates the generation of visual analytics, including interactive charts, heatmaps, and trend analyses. For instance, a query about drug efficacy trends across clinical trial phases may result in a bar chart or scatter plot illustrating response rates for each drug. The analytics engine 250 may also create comparative reports by juxtaposing metrics from different datasets, such as public and proprietary data. The analytics engine 250 supports user-defined configurations tailor analyses to users' specific needs. For example, researchers studying cardiovascular diseases might configure the analytics engine 250 to prioritize data related to heart disease biomarkers, therapies, and patient demographics. Additionally, the analytics engine 250 supports multi-modal analysis, combining text, numerical data, and visual inputs for a comprehensive view.

In some embodiments, the analytics engine 250 incorporates domain-specific models and ontologies to enhance its analytical capabilities. For instance, in life sciences, the analytics engine 250 may include models trained to identify molecular pathways associated with drug toxicity or efficacy. Similarly, in finance, the analytics engine 250 may analyze market trends to identify correlations between economic indicators and asset performance.

The front-end interface 255 may be a software application interface that is provided and operated by the knowledge management system 110. For example, the knowledge management system 110 may provide a SaaS platform or a mobile application for users to manage data. The front-end interface 255 may display a centralized platform in managing research, knowledge, articles and research data. The front-end interface 255 creates a knowledge management platform that facilitates the organization, retrieval, and analysis of data, enabling users to efficiently access and interact with the knowledge graph, perform queries, generate visualizations, and manage permissions for collaborative research activities.

The front-end interface 255 may take different forms. In one embodiment, the front-end interface 255 may control or be in communication with an application that is installed in a client device 130. For example, the application may be a cloud-based SaaS or a software application that can be downloaded in an application store (e.g., APPLE APP STORE, ANDROID STORE). The front-end interface 255 may be a front-end software application that can be installed, run, and/or displayed on a client device 130. The front-end interface 255 also may take the form of a webpage interface of the knowledge management system 110 to allow clients to access data and results through web browsers. In some embodiments, the front-end interface 255 may not include graphical elements but may provide other ways to communicate, such as through APIs.

In some embodiments, various engine in the knowledge management system 110 support integration with external tools and platforms. For example, researchers might export the results of an analysis to external software for further exploration or integration into larger workflows. These capabilities enable the knowledge management system 110 to serve as a central hub for generating, visualizing, and disseminating data-driven insights.

In some embodiments, one or more machine learning models 260 can enhance the analytical capabilities of the knowledge management system 110 by identifying patterns, predicting outcomes, and generating insights from complex and diverse datasets. A machine learning model 260 may be used to identify entities, fuse entities, analyze relationships within the knowledge graph, detect trends in clinical trial data, or classify entities based on entities' features. A model can perform tasks such as clustering similar data points, identifying anomalies, or generating simulations based on input parameters.

In some embodiments, different machine learning models 260 may take various forms, such as supervised learning models for tasks like classification and regression, unsupervised learning models for clustering and dimensionality reduction, or reinforcement learning models for optimizing decision-making processes. Transformer-based architectures may also be employed, including encoder-only models, such as BERT, encoder-decoder models, for tasks like entity extraction and semantic analysis; decoder-only models, such as GPT, for generating textual responses or summaries; and encoder-decoder models, for complex tasks requiring both contextual understanding and generative capabilities, such as machine translation or summarization. Domain-specific variations of transformers, such as BioBERT for biomedical text, SciBERT for scientific literature, and AlphaFold for protein structure prediction, may also be integrated. AlphaFold, for example, uses transformer-based mechanisms to predict three-dimensional protein folding from amino acid sequences, providing valuable insights in the life sciences domain.

### Knowledge Graph Generation

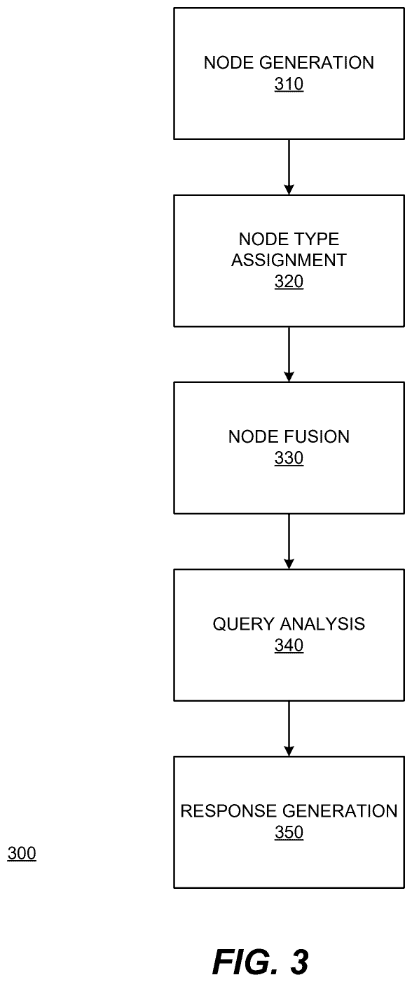

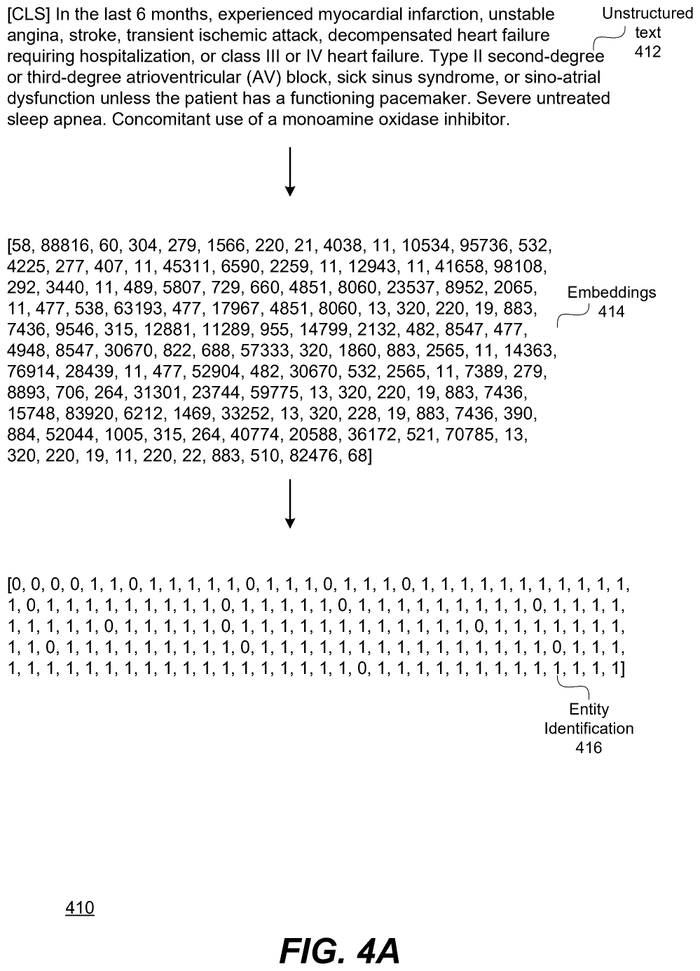

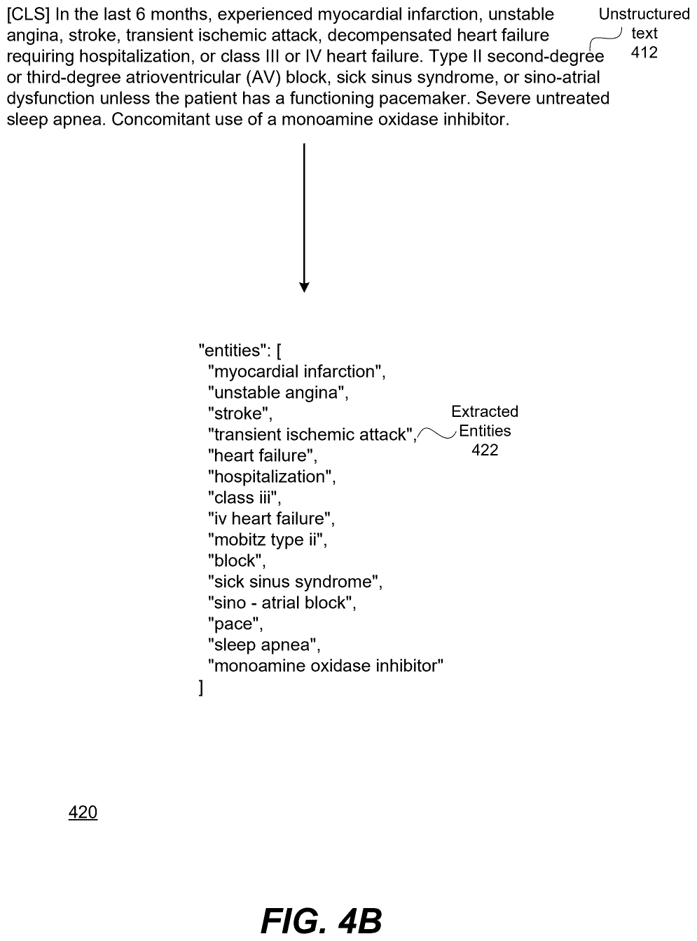

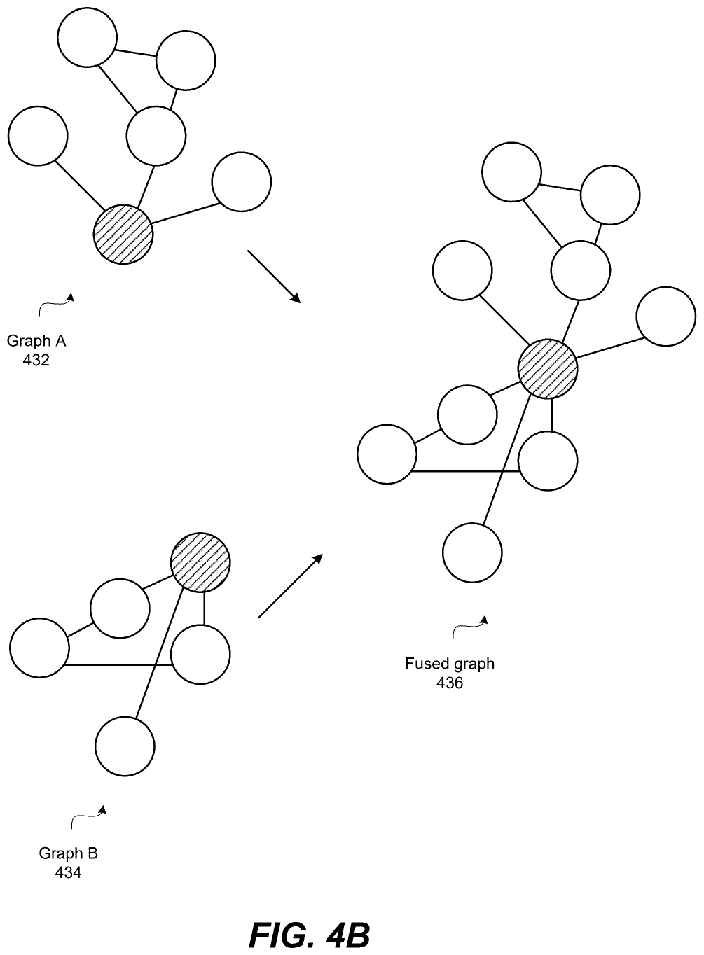

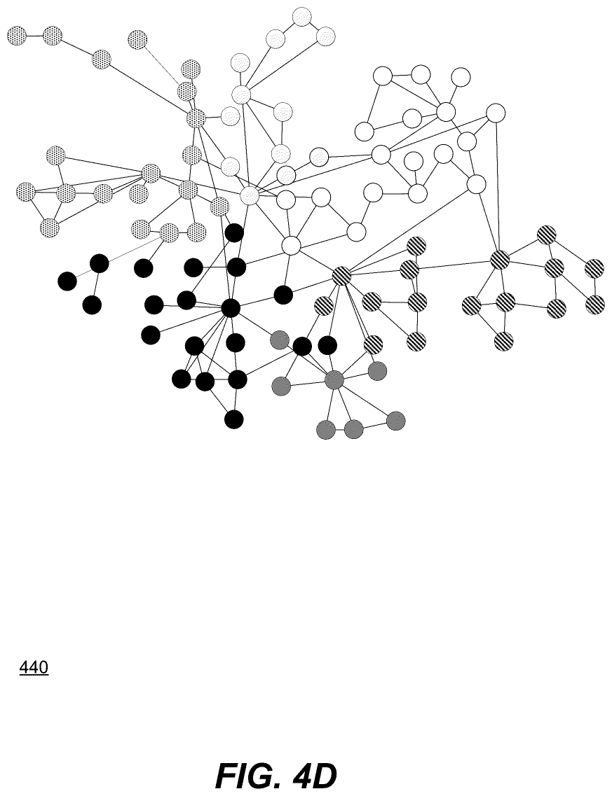

FIG. 3 is a flowchart illustrating a process 300 for generating a knowledge graph and responding to a query based on the knowledge graph, in accordance with some embodiments. The process 300 may include node generation 310, node type assignment 320, node fusion 330, query analysis 340, and response generation 350. In various embodiments, the process 300 may include additional, fewer, or different steps. The details in the steps may also be distributed in a different manner described in FIG. 3. FIG. 4A through FIG. 4D are graphical illustration of various parts in FIG. 3. FIG. 4A through FIG. 4D will be discussed in conjunction with FIG. 3.

In some embodiments, at node generation stage 310, the knowledge management system 110 processes unstructured text to generate nodes in a knowledge graph. The knowledge management system 110 may convert the input text into embeddings, such as using the techniques discussed in the vectorization engine 220. For example, the vectorization engine 220 may employ various embedding techniques, including encoder-only transformers, to analyze and represent textual data in a latent high-dimensional space. FIG. 4A is a graphical illustration of the entity identification process in the node generation stage 310. For example, an unstructured text 412, which may correspond to a sentence or a paragraph in a research paper, is converted into embeddings 414. The numerical value of each embedding 414 is for illustration only and does not represent the actual value of an embedding.

In response to embeddings being created, the knowledge management system 110 determines whether each embedding corresponds to an entity. The knowledge management system 110 may apply classification methods, such as multi-target binary classification. Further detail and examples of techniques used in entity classification are discussed in FIG. 2 in association with the entity identifier 225. The knowledge management system 110 may evaluate a set of embeddings to identify multiple entities within a single dataset simultaneously. For instance, when analyzing a research article, the knowledge management system 110 may detect entities like diseases, drugs, or clinical outcomes, assigning a binary classification for each target category. This classification can be enhanced with domain-specific models or ontologies to refine the identification process further. Referring to FIG. 4A, the figure illustrates that each embedding 414 is classified as a binary classification of entity identification 416. For example, an embedding 414 that is determined as non-entity is assigned a value “0” in the entity identification 416. An embedding 414 that is determined as an entity is assigned a value “1” in the entity identification 416. Note that the example binary values in FIG. 4A are for illustration only and do not represent the actual values.

FIG. 4B illustrates a result of entity extraction from an unstructured text 412. From the unstructured text 412, a set of extracted entities 422 are generated. The extracted entities 422 may be represented as nodes in a knowledge graph and the relationships among the set of extracted entities 422 (e.g., the entities being in the same sentence or same paragraph, or semantic relationships, or other edge relationships) are represented as edges in the knowledge graph. In some embodiments, each node may include attributes, such as the entity's type, name, and source information. The knowledge management system 110 links the entities to the entities' originating data to allow for traceability and contextual relevance within the broader knowledge graph.

In some embodiments, at node assignment stage 320, the knowledge management system 110 performs node type assignment to categorize an identified node into one or more predefined types. The knowledge management system 110 may analyze the embedding representations of nodes generated during the previous stage. The embeddings 414, which encode semantic and contextual information, are processed using a classification algorithm to assign a specific label to each node. The classification algorithm may be a multi-class or hierarchical classifier, depending on the granularity of the node types required.

The knowledge management system 110 employs context-aware models to understand the relationships and attributes of nodes. For example, if the nodes represent terms extracted from a dataset, the system evaluates their co-occurrence with known keywords, their syntactic structure, and their semantic similarities to existing labeled examples. This evaluation assigns nodes such as “diabetes” as diseases, while “insulin” is categorized as a drug.

In some embodiments, the knowledge management system 110 supports multi-target classification. For instance, a term like “angiogenesis” may be classified as both a molecular pathway and a therapeutic target, depending on its context in the data. The knowledge management system 110 may resolve such ambiguities by analyzing broader relationships, such as the presence of related entities or corroborative textual evidence within the dataset.

In some embodiments, the node assignment process incorporates domain-specific ontologies, which provide hierarchical definitions and relationships for entities. For instance, in the context of life sciences, the system may refer to ontologies that delineate diseases, treatments, and biomarkers. Additionally, the knowledge management system 110 employs probabilistic scoring to handle uncertain classifications. Nodes may be assigned a confidence score based on the strength of their alignment with predefined types. If a node does not meet the confidence threshold, the knowledge management system 110 may flag the node for further review.

In some embodiments, at node fusion stage 330, the knowledge management system 110 performs node fusion to consolidate nodes representing identical or closely related entities across the dataset. This process eliminates redundancy and improves the knowledge graph by maintaining a consistent structure with minimal duplication. The knowledge management system 110 evaluates textual, contextual, and embedding-based similarities to determine whether nodes should be merged.

In the node fusion process, the knowledge management system 110 employs a variety of techniques to consolidate nodes that represent the same or similar entities. The knowledge management system 110 may identify candidate nodes for fusion. Text matching is one example approach, focusing on direct comparisons of textual representations to identify equivalence or near equivalence. Text matching includes perfect matching strategies such as identifying exact matches, stripping symbols to detect equivalence (e.g., “a-b” and “a b”), and matching text in a case-insensitive manner (e.g., “a b” and “A B”). Nodes with identical or nearly identical text representations are flagged as potential duplicates. For example, if one node is labeled as “Multiple Sclerosis” and another as “MS,” the knowledge management system 110 detects a potential match based on direct equivalence or domain-specific normalization rules, such as removing case sensitivity or abbreviations.

In addition to or in alternative to simple text matching, the knowledge management system 110 employs embedding-based comparisons to evaluate semantic similarity. Each node is represented as an embedding 414 in a high-dimensional space. The knowledge management system 110 may calculate proximity between the embeddings 414 using measures such as cosine similarity. For example, embeddings for terms like “MS,” and “Multiple Sclerosis,” may cluster closely, indicating semantic equivalence.

In some embodiments, the knowledge management system 110 may also apply contextual analysis to further refine the node fusion stage 330. The knowledge management system 110 examines the relationships of candidate nodes within the knowledge graph, including the nodes edges and connected entities. Nodes sharing identical or highly similar connections are likely to represent the same entity. For example, if two nodes, “Transient Ischemic Attack” and “TIA,” are both linked to the same clinical trials and treatments, the knowledge management system 110 may merge the two entities based on relational equivalence. The knowledge management system 110 leverages question-and-answer techniques using language models. The language models may interpret queries and provide contextual validation for potential node mergers. For instance, a query such as “Is ozanimod the same as Zeposia?” allows the knowledge management system 110 to evaluate the equivalence of nodes based on nuanced context and additional data.

Further examples of how nodes may be fused are discussed in FIG. 2 in association with the knowledge graph constructor 235.

The output of node fusion stage 330 may take the form of a largely de-duplicated and unified set of nodes arranged as the knowledge graph. The knowledge graph may define the data structure for the unstructured text in the corpus. Each fused node represents a consolidated entity that integrates all relevant information from its original components. FIG. 4C is a graphical illustration of a node and graph fusion process. The knowledge management system 110 may generate a graph A 432 that represents the entity relationships of a research paper A and a graph B 434 that represents the entity relationship of a research paper B. The knowledge management system 110, at the node fusion stage 330, determines that the shaded nodes in both graphs 432 and 434 are the same entity and should be fused. After the fusion, the two graphs 432 and 434 are merged to create a larger knowledge graph.

FIG. 4D is a conceptual illustration of a large knowledge graph 440, in accordance with some embodiments. The large knowledge graph 440 may be fused from smaller knowledge graphs representing a number of documents in the corpus, using the node fusion stage 330. The knowledge management system 110 may store metadata of nodes in the large knowledge graph 440. Different values of metadata are represented as different shading in FIG. 4D. The metadata may indicate the entity origin, types of entities, and connections of entities. For example, one field of the metadata may represent the document source of the entities and the entities that are from the same document may be shaded with the pattern in FIG. 4D. Alternatively, or additionally, another field of the metadata may represent the entity type and the same shading in FIG. 4D may represent the same entity type (e.g., diseases are shaded with the same pattern). Alternatively, or additionally, another field of the metadata may represent a grouping of questions. For example, the knowledge management system 110, in converting each unstructured document to entities, may extract the questions that are relevant to sub-sections in the document. Different documents may have sections that are common to the same question (e.g., what is the toxicity level of drug A to indication A). The knowledge management system 110 may group the entities based on the questions. The questions may be implemented as entities in the large knowledge graph 440. Alternatively, or additionally, the questions may be implemented in a metadata field in the large knowledge graph 440 so that the large knowledge graph 440 can be organized and filtered by the questions. Other suitable metadata fields are also possible. The level of granularity of the metadata fields may vary depending on embodiments. For example, the large knowledge graph 440 may group entities by documents, by paragraphs, by sentences, by questions, etc.

Referring back to FIG. 3, in some embodiments, at query analysis stage 340, the knowledge management system 110 performs query analysis to interpret and transform user-provided inputs or system-generated requests into a format that aligns with the structure of the knowledge graph 440. The knowledge management system 110 may receive a query, which may take various forms, such as natural language questions, keyword-based searches, or analytical prompts. The query may be processed by vectorization engine 220 to generate one or more embeddings that captures the meaning and context of the input. For instance, a user query such as “What treatments are available for multiple sclerosis?” can be converted into multiple embeddings. The knowledge management system 110 may use various natural language processing (NLP) techniques to decompose the query into the constituent components, such as entities, relationships, and desired outcomes. The knowledge management system 110 may perform entity recognition to identify the entities in the query and decompose the query into entities, context, and relationships. The decomposition may involve syntactic parsing to identify the query's grammatical structure, semantic analysis to determine the meaning of its components, and entity recognition to extract relevant terms. For example, the term “multiple sclerosis” might be mapped to a disease node in the knowledge graph 440, while “treatments” may correlate with drug or therapy nodes.

In some embodiments, the knowledge management system 110 may also perform intent analysis to determine the purpose of the query. Intent analysis identifies whether the user seeks statistical data, relational insights, or specific entities. For example, the knowledge management system 110 might infer that a query about “clinical trial outcomes for drug X” is requesting a structured dataset rather than a textual summary.

The system further translates the query into a structured format compatible with graph traversal algorithms. This format includes specific instructions for searching nodes, edges, and attributes within the knowledge graph. For example, a query asking for “phase 2 clinical trials for drug Y” is converted into a set of instructions to locate nodes labeled “drug Y,” traverse edges connected to “clinical trials,” and filter results based on attributes indicating “phase 2.” The query may be converted into one or more structural queries such as SQL queries that retrieve relevant data to provide answers to the query.

In some embodiments, the query analysis may also integrate contextual understanding, domain specific knowledge, historical interactions with a particular user, and/or user preferences stored in the knowledge management system 110. For example, if a user frequently queries biomarkers related to oncology, the knowledge management system 110 may prioritize oncology-related nodes and relationships when interpreting subsequent queries.

In some embodiments, the query analysis may also be question based. In some embodiments, the knowledge management system 110 pre-identify a list of questions that are relevant to each document in the corpus and store the list of questions in the knowledge graph 440. The lists of questions may also be converted into embeddings. In response to receiving a query, the knowledge management system 110 may convert the query into one or more embeddings and identify which question embeddings in the large knowledge graph 440 are relevant or most relevant to the query embedding. In turn, the knowledge management system 110 uses the identified question embeddings to identifies entities that should be included in the response of the query.

In some embodiments, based on the various query analyses 340, the knowledge management system 110 may produce one or more refined, structured query representations that can executed in searching the knowledge graph 440 and/or other data structures.

In some embodiments, at response generation stage 350, the knowledge management system 110 generate a response to an analyzed query to synthesize and deliver information that directly addresses the query interpreted in the query analysis stage 340. The response generation may include retrieving relevant data from various sources, such as the knowledge graph, data stores that include various data, and the documents in the corpus. In turn, the knowledge management system 110 may format the retrieved data appropriately and synthesizing the data into a cohesive output for the user.

In some embodiments, the knowledge management system 110 may traverse a knowledge graph 440 to locate nodes, edges, and associated attributes that match the query's parameters. For example, a query for “approved treatments for multiple sclerosis” prompts the system to identify nodes categorized as drugs and filter the nodes based on relationships or attributes indicating regulatory approval for treating “multiple sclerosis.” The knowledge management system 110 may also determine the optimal format for presenting the results. This determination depends on the query's context and the type of information requested. For instance, if the query asks for numerical data, such as “response rates in phase 2 trials for drug X,” the knowledge management system 110 may organize the data into a structured table. If the query seeks relational insights, such as “connections between biomarkers and drug efficacy,” the knowledge management system 110 may invoke a generative AI tool (e.g., a generative model provided by the model serving system 145) to generate a visual graph highlighting the relationships between the relevant nodes.

In some embodiments, in generating responses, the knowledge management system 110 may apply text summarization techniques when appropriate. For example, if a query requests a summary of clinical trials for a specific drug, the knowledge management system 110 may condense information from the associated nodes and edges into a concise, natural language paragraph. The knowledge management system 110 may also integrate contextual enhancements to improve the user experience. For example, if the knowledge management system 110 identifies gaps or ambiguities in the query, the knowledge management system 110 may invoke a generative model to supplement the information or follow-up suggestions. For a query about “biomarkers for cancer treatments,” the response might list the biomarkers and propose related queries, such as “What clinical trials involve these biomarkers?” Where the response requires visualizations, such as charts or graphs, the knowledge management system 110 may employ the analytics engine 250 to create interactive representations. For instance, a bar chart comparing the efficacy of multiple drugs in treating a condition might be generated, with each bar representing a drug and its associated response rate.

In response to receiving a query, the knowledge management system 110 delivers a response to the user, tailored to the query's intent and enriched with contextual or supplementary insights as needed. The generated response facilitates user decision-making and further exploration by presenting precise, actionable information derived from the knowledge graph 440.

### Prompt-Based Document Retrieval Process

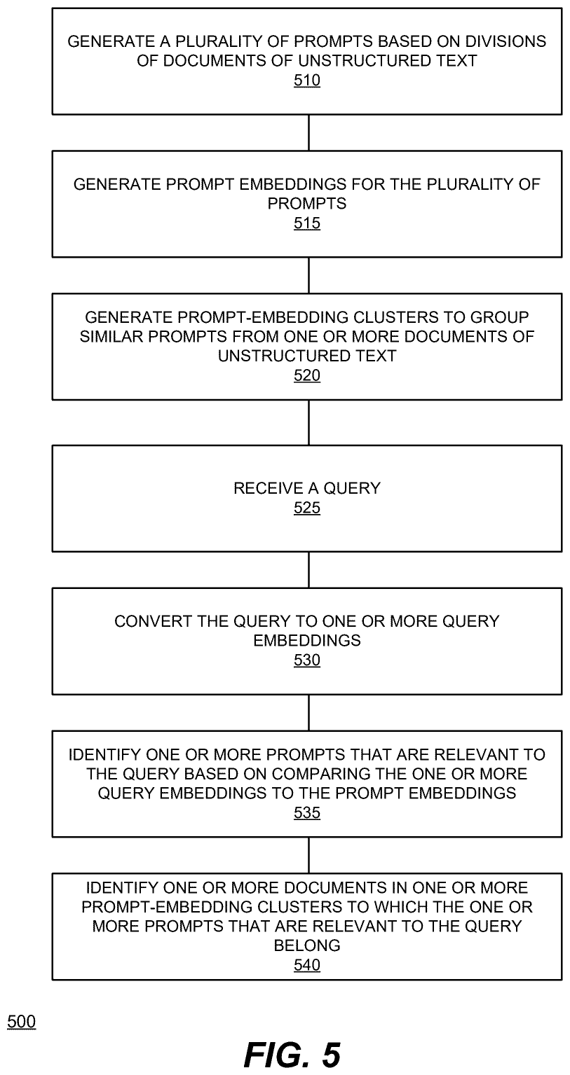

FIG. 5 is a flowchart depicting an example process 500 for performing prompt-based documents retrieval to improve the retrieval speed and accuracy of documents, in accordance with some embodiments. While the process 500 is primarily described as being performed by the knowledge management system 110, in various embodiments the process 500 may also be performed by any suitable computing devices. In some embodiments, one or more steps in the process 500 may be added, deleted, or modified. In some embodiments, the steps in the process 500 may be carried out in a different order that is illustrated in FIG. 5.

In some embodiments, the knowledge management system 110 may generate 510 a plurality of prompts based on divisions of documents of unstructured text. In some embodiments, each prompt is relevant to a division of unstructured text. In some embodiments, at least one prompt is generated such that a corresponding division of unstructured text is a response to said at least one prompt. In some embodiments, to generate the plurality of prompts based on divisions of documents of unstructured text, the knowledge management system 110 may segment the documents into paragraphs, sentences, or multi-paragraph sections. The segmentation ensures that the generated prompts are contextually focused on specific divisions of the document. In some embodiments, the knowledge management system 110 may apply a language model to generate one or more prompts for each segment, wherein the generated prompts are contextually relevant to the content of the corresponding segment. For instance, the language model may analyze the semantic and syntactic structure of each segment to create prompts that accurately reflect the core information in the segment.

In some embodiments, the generated prompts may include various types of queries tailored to the division's content. For example, in the context of a research article, the knowledge management system 110 may generate prompts in the form of specific questions, such as “What are the key findings of this section?” or “What methods were used in the experiment described in this paragraph?” These prompts help establish a direct link between the unstructured text and the structured retrieval processes downstream.

In some embodiments, at least a subset of the plurality of prompts generated are questions. Each question is derived by the knowledge management system 110 to elicit specific information from the corresponding division of text. For example, for a given a section (e.g., a sentence, a paragraph, a few paragraphs, a graph) in a document (e.g., a research paper), the knowledge management system 110 generates one or more questions that correspond to what the section is trying to explain.

In some embodiments, the knowledge management system 110 may generate 515 prompt embeddings for the plurality of prompts. The plurality of prompts correspond to the plurality of documents of unstructured text. In some embodiments, generating prompt embeddings involves processing each prompt to create a dense vector representation in a high-dimensional latent space of a neural network, capturing the semantic and contextual information of the prompt. In some embodiments, to generate the prompt embeddings for the plurality of prompts, the knowledge management system 110 may process each prompt using an encoder-only language model. The encoder-only language model may analyze the text of each prompt and generate an embedding vector that represents the prompt in a manner optimized for computational comparisons. Examples of encoder-only language models that may be used include Bidirectional Encoder Representations from Transformers (BERT) or other suitable transformer architectures tailored to the domain of the documents.

In some embodiments, the embedding vectors generated for the prompts are normalized to ensure consistency in subsequent similarity comparisons. The normalization process adjusts the values in the embedding vectors to ensure uniform scales, which improves clustering and retrieval accuracy in later steps.

Further details regarding the generation of embeddings, including the specific methods and models used, are described in association with the vectorization engine 220 in FIG. 2. For example, the vectorization engine 220 employs various techniques, such as attention mechanisms and tokenization, to create embeddings that capture the meaning and context of the text.

In some embodiments, the knowledge management system 110 may generate 520 prompt-embedding clusters to group similar prompts from one or more documents of unstructured text. In some embodiments, prompt embeddings are analyzed to identify similarities. The knowledge management system 110 organizes prompts (e.g., questions) into clusters that represent related concepts or themes. For example, the prompts are extracted from different documents in the corpus. This unified data structure transcends the boundaries of individual documents. By clustering prompts based on the prompts' similarity, the knowledge management system 110 creates a question-centric organization of the data. This structure allows related questions across various documents to be grouped together. For example, when a user asks a question similar to the prompts in the clusters, the system can quickly and accurately identify relevant entities, sections, and documents associated with that question. This organization not only reduces the time required for information retrieval but also enhances precision by narrowing down the search space to only the most relevant clusters. The prompt-driven clustering transforms the corpus into a structured, query-friendly format, ensuring that user queries are addressed with high relevance and minimal computational overhead.

In some embodiments, to generate the prompt-embedding clusters, the knowledge management system 110 may apply a clustering algorithm to group embedding vectors based on similarity. Clustering algorithms may include k-means clustering, hierarchical clustering, density-based spatial clustering, spectral clustering, or other suitable techniques. The choice of clustering algorithm may depend on the nature of the embedding data and the desired granularity of the clusters. In some embodiments, the knowledge management system 110 may recursively subdivide larger clusters into smaller clusters to refine the grouping further. For example, an initial cluster representing general prompts about a topic (e.g., “clinical trials”) may be subdivided into smaller clusters focusing on specific subtopics, such as “trial phases,” “outcomes,” or “participant demographics.”

The clustering process allow prompts with high similarity to be grouped together, facilitating efficient data retrieval and improving the organization of related information. For instance, prompts derived from different documents but addressing similar questions or topics can be clustered to streamline subsequent search and response processes. In some embodiments, metadata may be associated with the prompt-embedding clusters. The metadata may include identifiers of the documents from which the prompts were derived and predefined topics or categories associated with each cluster. The metadata allows for contextual filtering and prioritization during query resolution.

In some embodiments, the knowledge management system 110 may receive 525 a query seeking information from the documents of unstructured text. The query may serve as an input for the system to identify relevant prompts, documents, or entities that address the user's informational needs.

In some embodiments, queries may be generated in different manners. For example, in some cases, a query may be manually inputted by a user through an interface, such as a graphical user interface (GUI) or an application programming interface (API). The interface may allow users to express their queries in natural language or through predefined input formats. For example, a user might input a query such as, “What are the approved treatments for disease X?” or “Provide a summary of clinical trial outcomes for drug Y.” In other cases, a query may be automatically generated based on a topic of project context specified by the user. For instance, the knowledge management system 110 may utilize predefined keywords, project parameters, or prior interactions to generate a query suggestion aligned with a user's research focus. As an example, if a user is exploring a project on cardiovascular diseases, the system may generate queries such as, “List all biomarkers associated with myocardial infarction” or “Summarize phase 3 clinical trial results for hypertension treatments.” The suggested query may be further amended by the user.

Further details regarding query input and analysis mechanisms, are described in FIG. 2, particularly in association with the query engine 240.

In some embodiments, the knowledge management system 110 may convert 530 the query to one or more query embeddings. In some embodiments, the conversion process involves transforming the query into a dense vector representation in a high-dimensional latent space. This transformation may capture the semantic and contextual information of the query, facilitating comparison with prompt embeddings.

In some embodiments, to convert the query to query embeddings, the knowledge management system 110 may tokenize the query into a sequence of text tokens. Tokenization involves breaking the query text into smaller, syntactically meaningful units, such as words, phrases, or subwords. These tokens provide the input format necessary for embedding generation. In some embodiments, the sequence of text tokens is processed using an encoder-only language model to generate the query embeddings. The encoder-only language model analyzes the tokenized query, capturing its semantic and syntactic relationships within the high-dimensional latent space. Examples of encoder-only language models include BERT, Sentence-BERT, or other transformer-based architectures optimized for natural language processing. Further details on the embedding generation process, including the operations of the vectorization engine 220, are described in association with FIG. 2.

In some embodiments, the knowledge management system 110 may identify 535 one or more prompts that are relevant to the query based on comparing the one or more query embeddings to the prompt embeddings. In some embodiments, the system performs this identification by computing the similarity between the query embeddings and the prompt embeddings generated in step 515.

In some embodiments, the knowledge management system 110 computes a similarity score between the query embeddings and the prompt embeddings. The similarity score may be determined using techniques such as cosine similarity, which measures the angular distance between two embedding vectors in a high-dimensional space. In some embodiments, the knowledge management system 110 selects prompts with similarity scores above a predefined threshold to select prompts that are closely aligned with the meaning and context of the query. In some embodiments, the relevance of a prompt is further refined by analyzing metadata or contextual attributes associated with the prompt embeddings. For instance, the metadata may include information about the document source, topic, or category associated with each prompt, which helps the system prioritize the most contextually accurate matches for the query.

In some embodiments, to enhance the identification process, the knowledge management system 110 may leverage a knowledge graph (e.g., a large knowledge graph 440) that represents the relationships between prompts, documents, and associated entities. In some embodiments, the knowledge graph includes nodes representing prompts and entities extracted from the documents and edges representing relationships between the prompts and the documents. When identifying relevant prompts, the knowledge management system 110 may traverse the knowledge graph to locate nodes corresponding to prompts that are most closely aligned with the query embeddings.

In some embodiments, identifying relevant prompts comprises selecting a node in the knowledge graph corresponding to a prompt-embedding that matches the query embedding. The knowledge management system 110 may then traverse edges from the identified node to related nodes based on predefined traversal criteria. The traversal criteria may include edge relevance values or entity types. For instance, the system may prioritize traversal paths with the highest edge relevance scores to focus on the most significant relationships. For example, edge relevance values may quantify the strength of the relationship between nodes, such as the frequency of co-occurrence between a prompt and a document section or a confidence score assigned by a machine learning model analyzing their connection. Entity types may classify nodes into predefined categories, such as document sections, extracted entities, or prompts, enabling the system to filter or prioritize paths based on the type of information sought by the query.

The knowledge management system 110 may prioritize traversal paths with the highest edge relevance scores to focus on the most significant relationships. The prioritization can involve ranking edges dynamically based on their relevance scores, allowing the system to efficiently narrow down the search space to only the most pertinent nodes. Additionally, or alternatively, the knowledge management system 110 may adjust the traversal strategy based on the context of the query, such as favoring edges connecting prompts to specific entity types (e.g., diseases, treatments, or outcomes) when the query pertains to a particular domain of interest. The knowledge management system 110 may align the traversal with both the query's intent and the structural organization of the knowledge graph.

In some embodiments, the traversal of the knowledge graph may aggregate information from nodes encountered during the traversal process. For example, if a node represents a prompt closely related to the query, the traversal may extend to connected nodes representing additional prompts or associated entities. The aggregated information may then guide the identification of the most relevant prompts and their related document clusters.

In some embodiments, the knowledge management system 110 may identify 540 one or more documents in one or more prompt-embedding clusters to which the one or more prompts that are relevant to the query belong. As such, the knowledge management system 110 retrieves specific documents or sections of documents that correspond to the user query, leveraging the relationships between prompts and their respective documents.

In some embodiments, identifying the documents involves determining the association between prompts and their corresponding prompt-embedding clusters. Each cluster may represent a group of prompts that are semantically or contextually similar, as determined during the clustering process described in step 520. The knowledge management system 110 may analyze the query-related prompts and match them to their respective clusters to narrow down the relevant documents. In some embodiments, the knowledge management system 110 may rank the documents within the identified clusters based on relevance to the query embeddings. Relevance may be determined by computing similarity scores between the query embeddings and the prompt embeddings. Documents that include prompts with the highest similarity scores are prioritized for retrieval. In some embodiments, the knowledge management system 110 may further filter the ranked documents to include only those exceeding a predefined relevance threshold, thereby improving retrieval precision and reducing irrelevant results.

In some embodiments, additional metadata associated with the prompt-embedding clusters may assist in identifying the relevant documents. For example, the clusters may include document identifiers and predefined topics or categories that further refine the search results. These metadata attributes allow the system to prioritize documents aligned with the user's query context.

In some embodiments, the knowledge management system 110 may generate a response to the query by synthesizing and presenting data retrieved from the knowledge graph, prompt-embedding clusters, and other associated data structures. The response may be tailored to align with the type and context of the query. In some embodiments, generating the response to the query may involve retrieving relevant nodes and edges from the knowledge graph. The retrieved nodes and edges may be identified based on their relationships to the query embeddings. The retrieved information is synthesized into an output format, such as text, tables, or graphical representations. For example, a query seeking information about a drug's efficacy may result in a table summarizing clinical trial outcomes or a graph visualizing relationships between the drug, biomarkers, and patient demographics.

In some embodiments, the response may include a textual summary generated using a transformer-based language model. The summary incorporates entities and relationships relevant to the query, offering users a concise yet informative narrative. Alternatively, the response may include a structured table summarizing numerical data, such as statistical metrics or experimental results, derived from the documents associated with the entities in the knowledge graph.

In some embodiments, the response may include an interactive visualization. For instance, the visualization may display nodes representing entities relevant to the query and edges indicating relationships between these entities. The knowledge management system 110 may enable user interaction with the visualization, allowing users to explore relationships between entities dynamically and refine their query results. For example, a user investigating a specific molecular pathway could interact with the visualization to uncover associated drugs, diseases, or biomarkers.

In some embodiments, the knowledge management system 110 adapts the format and complexity of the response based on the query's context and type. If the query requests numerical or structured data, the system may provide outputs such as bar charts, scatter plots, or comparison tables. Alternatively, if the query seeks conceptual or relational insights, the system may employ natural language generation or visual representations to deliver the response.

### Example Graphical User Interfaces

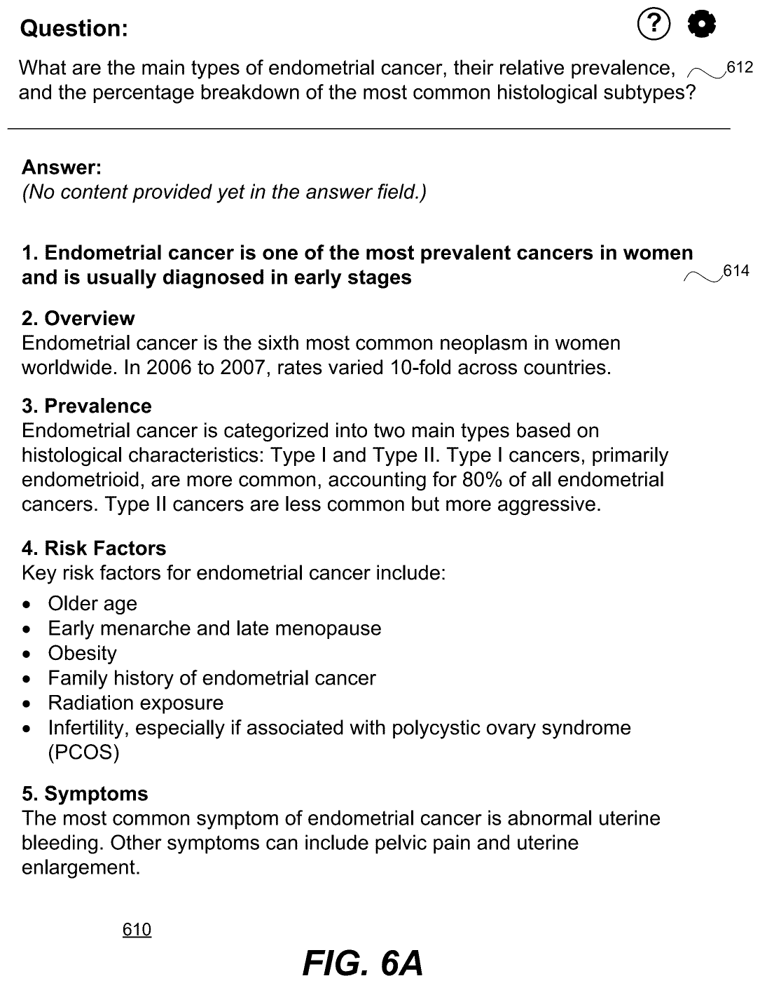

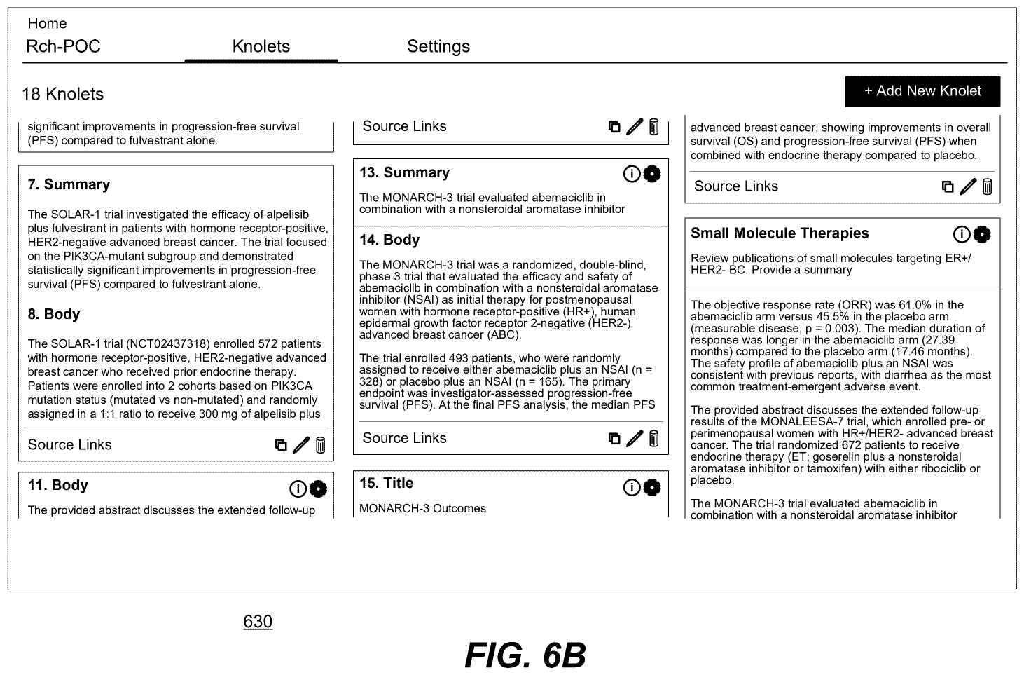

FIG. 6A is a conceptual diagram illustrating an example graphical user interface (GUI) 610 that is part of a platform provided by the knowledge management system 110, in accordance with some embodiments. In some embodiments, the GUI 610 may include a prompt panel 612 located at the top of the interface, which allows users to input a prompt manually or utilize an automatically generated prompt based on project ideas, such as “small molecule therapies” This prompt panel 612 may include a text input field, an auto-suggestion dropdown menu, or clickable icons for generating prompts dynamically based on pre-defined contexts or project objectives. In some embodiments, the GUI 610 may also include a summary panel 614 prominently displaying results based on the inputted or generated prompt. The content in the summary panel 614 is a response to the prompt. The generation of the content may be carried out by the processes and components that are discussed previously in this disclosure in FIG. 2 through FIG. 5. Although only text is displayed in the particular example shown in FIG. 6A, in various embodiments, the summary panel 614 may include visually distinct sections for organizing retrieved data, such as bulleted lists, numbered categories, or collapsible headings to enable quick navigation through results. The summary panel 614 may also include interactive features, such as checkboxes or sliders, allow users to customize their query further. In some embodiments, the GUI 610 may include visualization to display structured data graphically, such as bar charts, tables, or node-link diagrams. The visualization may enhance comprehension by summarizing relationships, trends, or metrics identified in the retrieved information. Users can interact with this panel to explore details, such as clicking on chart elements to access more granular data.

FIG. 6B is a conceptual diagram illustrating an example graphical user interface (GUI) 630 that is part of a platform provided by the knowledge management system 110, in accordance with some embodiments. The platform currently shows a project view that includes a number of prompts located in different panels. In some embodiments, the GUI 630 may include a project dashboard displaying multiple panels, each corresponding to a distinct prompt. The panels may be organized into a grid layout, facilitating a clear and systematic view of the information retrieved or generated for the project. The prompts displayed in the panels can either be manually generated by a user or automatically generated by the knowledge management system based on the context of a project or predefined queries.

In some embodiments, in the GUI 630, each panel may include a title section that specifies the topic or focus of the prompt, providing a response to the prompt that is included in the panel. Similar to FIG. 6A, the generation of the content may be carried out by the processes and components that are discussed previously in this disclosure in FIG. 2 through FIG. 5. The main body of the panel contains detailed text, such as summaries, analyses, or other content relevant to the prompt. The text area may feature scrolling capabilities to handle longer responses while maintaining the panel's compact size. In some embodiments, each panel may include actionable controls, such as icons for editing, deleting, or adding comments to the prompt or its associated data. Additionally, a “Source Links” section may be present at the bottom of each panel, enabling users to trace back to the original data or references for further verification or exploration. The identification of entities and sources may be carried out through traversing a knowledge graph, as discussed in FIG. 2 through FIG. 5. In some embodiments, the GUI 630 may also include a navigation bar or menu at the top for project management tasks, such as creating new projects, switching between projects, or customizing the layout of the panels.

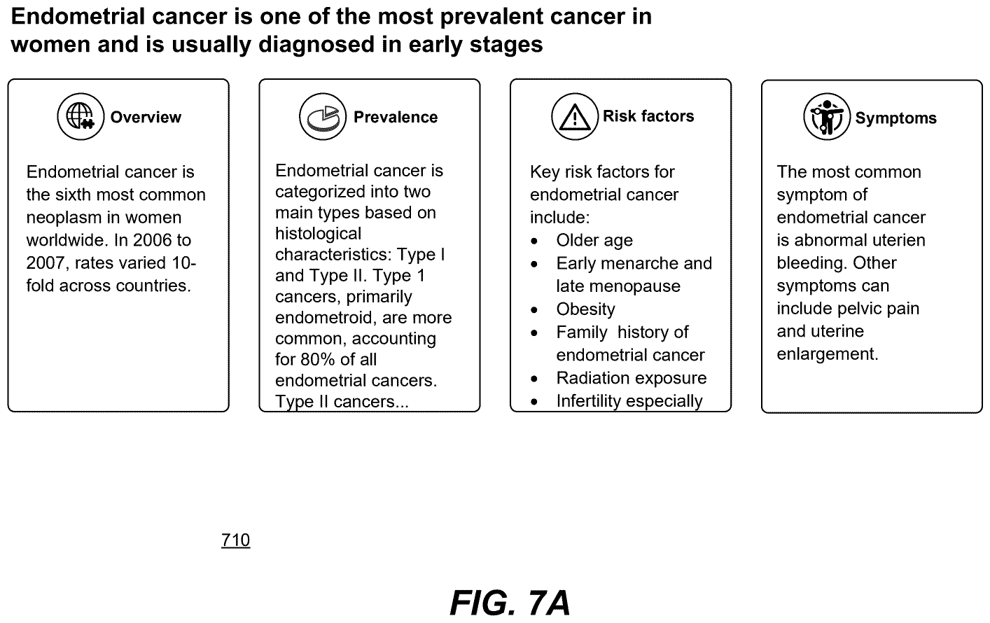

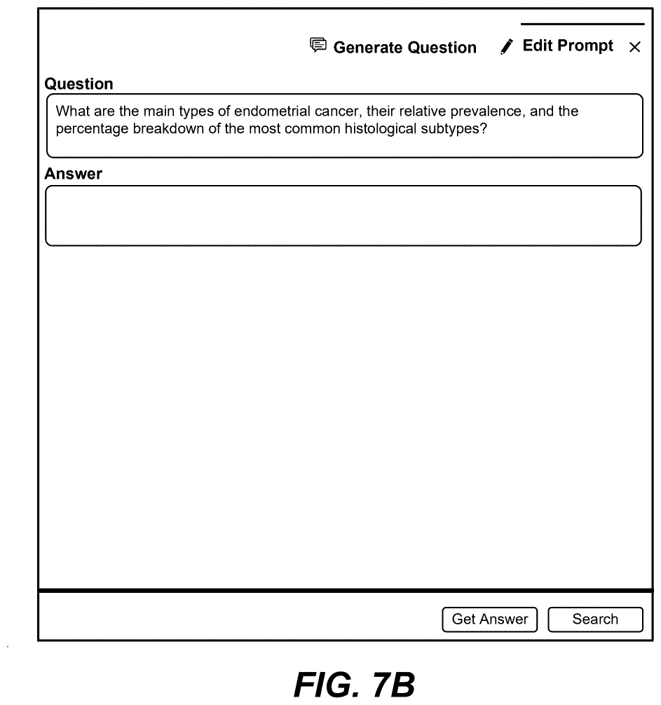

FIG. 7A is a conceptual diagram illustrating an example graphical user interface (GUI) 710 that is part of a platform provided by the knowledge management system 110, in accordance with some embodiments. The platform shows an analytics view that allows user to request the platform to generate in-depth analytics. In some embodiments, the GUI 710 may include an analytics dashboard designed to present in-depth insights in a visually intuitive and organized manner. The dashboard may include multiple panels, each focusing on a specific aspect of the analytics, such as summaries, statistical trends, associated factors, or predictive insights derived from the analytics engine 250. Additional examples of analytics are discussed in FIG. 2 in association with the analytics engine 250. These panels may be arranged in a grid or carousel layout. In some embodiments, each panel may feature a title bar that clearly labels the topic of the analytics, such as “Overview,” “Prevalence,” “Risk Factors,” or “Symptoms.” The topics may be automatically generated using the processes and components described in FIG. 2 through FIG. 5 and may be specifically tailored to the topic at the top of the panel. The main body of each panel may present information in different formats, including bulleted lists, graphs, charts, or textual summaries, depending on the type of analysis displayed.

In some embodiments, interactive features may be embedded in the panels, such as expandable sections, tooltips for detailed explanations, or clickable icons for further exploration. Users may also have the option to customize the layout or filter analytics based on specific parameters, such as timeframes, population groups, or research contexts. The GUI 710 may also include a control panel or toolbar allowing users to request new analytics, export results, or modify the scope of the displayed data. Upon receiving a user selection of one of the analytics, the knowledge management system 110 may generate an in-depth report using the analytics engine 250.

FIG. 7B is a conceptual diagram illustrating an example graphical user interface (GUI) 730 that is part of a platform provided by the knowledge management system 110, in accordance with some embodiments. In some embodiments, the GUI 730 may include a question-answering panel designed to facilitate user interaction with prompts and generate structured responses. In some embodiments, the GUI 730 may include a prompt input section at the top of the panel. This section allows users to view, edit, or customize the prompt text. Prompts may be first automatically generated by the system, such as through process 500. Interactive features, such as an “Edit Prompt” button or inline editing options, enable users to refine the prompt text dynamically. Additionally, an optional “Generate Question” button may provide suggestions for alternative or improved prompts based on the system's analysis of the user's project or query context, such as using the process 500.

In some embodiments, the GUI 730 may include an answer input section beneath the prompt field. This section provides an open text area for the knowledge management system 110 to populate a response, such as using the processes and components discussed in FIG. 2 through FIG. 5. The knowledge management system 110 may auto-fill this area with a response derived from its knowledge graph or underlying data sources. In some embodiments, the GUI 730 may also feature action buttons at the bottom of the panel. For example, a “Get Answer” button allows users to execute the query and retrieve data from the knowledge management system 110, while a “Submit” button enables the user to finalize and save the interaction to create a panel such us one of those shown in FIG. 6B.

### Example Machine Learning Models

In various embodiments, a wide variety of machine learning techniques may be used. Examples include different forms of supervised learning, unsupervised learning, and semi-supervised learning such as decision trees, support vector machines (SVMs), regression, Bayesian networks, and genetic algorithms. Deep learning techniques such as neural networks, including convolutional neural networks (CNN), recurrent neural networks (RNN), long short-term memory networks (LSTM), transformers, and linear recurrent neural networks such as Mamba may also be used. For example, various embedding generation tasks performed by the vectorization engine 220, clustering tasks performed by the knowledge graph constructor 235, and other processes may apply one or more machine learning and deep learning techniques.

In various embodiments, the training techniques for a machine learning model may be supervised, semi-supervised, or unsupervised. In supervised learning, the machine learning models may be trained with a set of training samples that are labeled. For example, for a machine learning model trained to generate prompt embeddings, the training samples may be prompts generated from text segments, such as paragraphs or sentences. The labels for each training sample may be binary or multi-class. In training a machine learning model for prompt relevance identification, the training labels may include a positive label that indicates a prompt's high relevance to a query and a negative label that indicates a prompt's irrelevance. In some embodiments, the training labels may also be multi-class such as different levels of relevance or context specificity.

By way of example, the training set may include multiple past records of prompt-query matches with known outcomes. Each training sample in the training set may correspond to a prompt-query pair, and the corresponding relevance score or category may serve as the label for the sample. A training sample may be represented as a feature vector that includes multiple dimensions. Each dimension may include data of a feature, which may be a quantized value of an attribute that describes the past record. For example, in a machine learning model that is used to cluster similar prompts, the features in a feature vector may include semantic embeddings, cosine similarity scores, cluster assignment probabilities, etc. In various embodiments, certain pre-processing techniques may be used to normalize the values in different dimensions of the feature vector.

In some embodiments, an unsupervised learning technique may be used. The training samples used for an unsupervised model may also be represented by feature vectors, but may not be labeled. Various unsupervised learning techniques such as clustering may be used in determining similarities among the feature vectors, thereby categorizing the training samples into different clusters. In some cases, the training may be semi-supervised with a training set having a mix of labeled samples and unlabeled samples.

A machine learning model may be associated with an objective function, which generates a metric value that describes the objective goal of the training process. The training process may intend to reduce the error rate of the model in generating predictions. In such a case, the objective function may monitor the error rate of the machine learning model. In a model that generates predictions, the objective function of the machine learning algorithm may be the training error rate when the predictions are compared to the actual labels. Such an objective function may be called a loss function. Other forms of objective functions may also be used, particularly for unsupervised learning models whose error rates are not easily determined due to the lack of labels. In some embodiments, in prompt-to-query relevance prediction, the objective function may correspond to cross-entropy loss calculated between predicted relevance and actual relevance scores. In various embodiments, the error rate may be measured as cross-entropy loss, L1 loss (e.g., the sum of absolute differences between the predicted values and the actual value), or L2 loss (e.g., the sum of squared distances).

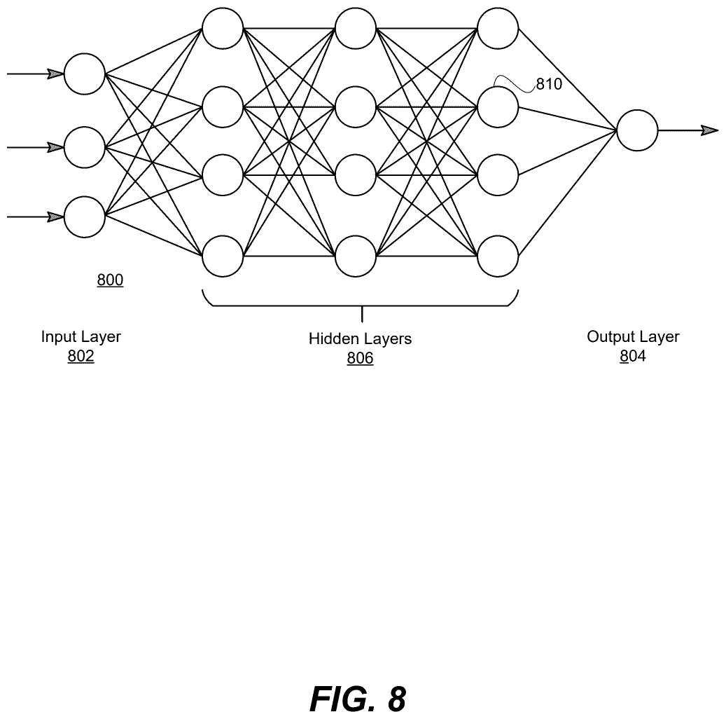

Referring to FIG. 8, a structure of an example neural network is illustrated, in accordance with some embodiments. The neural network 800 may receive an input and generate an output. The input may be the feature vector of a training sample in the training process and the feature vector of an actual case when the neural network is making an inference. The output may be the prediction, classification, or another determination performed by the neural network. The neural network 800 may include different kinds of layers, such as convolutional layers, pooling layers, recurrent layers, fully connected layers, and custom layers. A convolutional layer convolves the input of the layer (e.g., an image) with one or more kernels to generate different types of images that are filtered by the kernels to generate feature maps. Each convolution result may be associated with an activation function. A convolutional layer may be followed by a pooling layer that selects the maximum value (max pooling) or average value (average pooling) from the portion of the input covered by the kernel size. The pooling layer reduces the spatial size of the extracted features. In some embodiments, a pair of convolutional layer and pooling layer may be followed by a recurrent layer that includes one or more feedback loops. The feedback may be used to account for spatial relationships of the features in an image or temporal relationships of the objects in the image. The layers may be followed by multiple fully connected layers that have nodes connected to each other. The fully connected layers may be used for classification and object detection. In one embodiment, one or more custom layers may also be presented for the generation of a specific format of the output. For example, a custom layer may be used for question clustering or prompt embedding alignment.

The order of layers and the number of layers of the neural network 800 may vary in different embodiments. In various embodiments, a neural network 800 includes one or more layers 802, 804, and 806, but may or may not include any pooling layer or recurrent layer. If a pooling layer is present, not all convolutional layers are always followed by a pooling layer. A recurrent layer may also be positioned differently at other locations of the CNN. For each convolutional layer, the sizes of kernels (e.g., 3×3, 5×5, 7×7, etc.) and the numbers of kernels allowed to be learned may be different from other convolutional layers.

A machine learning model may include certain layers, nodes 810, kernels, and/or coefficients. Training of a neural network, such as the NN 800, may include forward propagation and backpropagation. Each layer in a neural network may include one or more nodes, which may be fully or partially connected to other nodes in adjacent layers. In forward propagation, the neural network performs the computation in the forward direction based on the outputs of a preceding layer. The operation of a node may be defined by one or more functions. The functions that define the operation of a node may include various computation operations such as convolution of data with one or more kernels, pooling, recurrent loop in RNN, various gates in LSTM, etc. The functions may also include an activation function that adjusts the weight of the output of the node. Nodes in different layers may be associated with different functions.

Training of a machine learning model may include an iterative process that includes iterations of making determinations, monitoring the performance of the machine learning model using the objective function, and backpropagation to adjust the weights (e.g., weights, kernel values, coefficients) in various nodes 810. For example, a computing device may receive a training set that includes segmented text divisions with prompts and embeddings. Each training sample in the training set may be assigned with labels indicating the relevance, context, or semantic similarity to queries or other entities. The computing device, in a forward propagation, may use the machine learning model to generate predicted embeddings or prompt relevancy scores. The computing device may compare the predicted scores with the labels of the training sample. The computing device may adjust, in a backpropagation, the weights of the machine learning model based on the comparison. The computing device backpropagates one or more error terms obtained from one or more loss functions to update a set of parameters of the machine learning model. The backpropagating may be performed through the machine learning model and one or more of the error terms based on a difference between a label in the training sample and the generated predicted value by the machine learning model.

By way of example, each of the functions in the neural network may be associated with different coefficients (e.g., weights and kernel coefficients) that are adjustable during training. In addition, some of the nodes in a neural network may also be associated with an activation function that decides the weight of the output of the node in forward propagation. Common activation functions may include step functions, linear functions, sigmoid functions, hyperbolic tangent functions (tanh), and rectified linear unit functions (ReLU).

After an input is provided into the neural network and passes through a neural network in the forward direction, the results may be compared to the training labels or other values in the training set to determine the neural network's performance. The process of prediction may be repeated for other samples in the training sets to compute the value of the objective function in a particular training round. In turn, the neural network performs backpropagation by using gradient descent such as stochastic gradient descent (SGD) to adjust the coefficients in various functions to improve the value of the objective function.

Multiple rounds of forward propagation and backpropagation may be performed. Training may be completed when the objective function has become sufficiently stable (e.g., the machine learning model has converged) or after a predetermined number of rounds for a particular set of training samples. The trained machine learning model can be used for performing prompt relevance prediction, document clustering, or question-based information retrieval or another suitable task for which the model is trained.

In various embodiments, the training samples described above may be refined and used to continue re-training the model, improving the model's ability to perform the inference tasks. In some embodiments, these training and re-training processes may repeat, resulting in a computer system that continues to improve its functionality through the use-retraining cycle. For example, after the model is trained, multiple rounds of re-training may be performed. The process may include periodically retraining the machine learning model. The periodic retraining may include obtaining an additional set of training data, such as through other sources, by usage of users, and by using the trained machine learning model to generate additional samples. The additional set of training data and later retraining may be based on updated data describing updated parameters in training samples. The process may also include applying the additional set of training data to the machine learning model and adjusting parameters of the machine learning model based on the applying of the additional set of training data to the machine learning model. The additional set of training data may include any features and/or characteristics that are mentioned above.

### Computing Machine Architecture

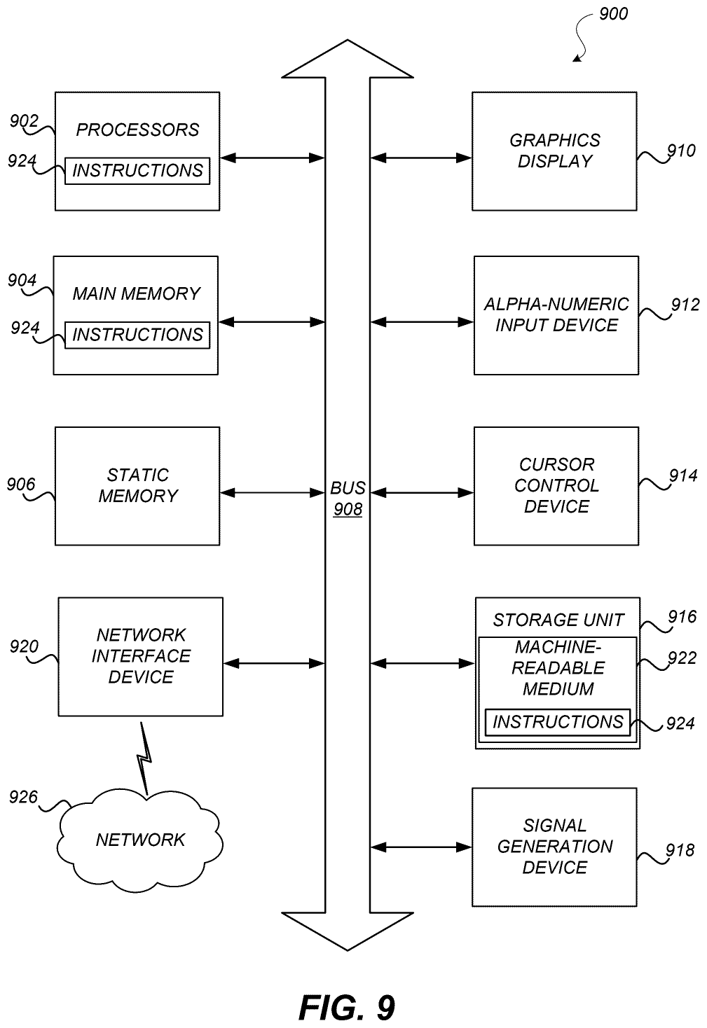

FIG. 9 is a block diagram illustrating components of an example computing machine that is capable of reading instructions from a computer-readable medium and executing them in a processor (or controller). A computer described herein may include a single computing machine shown in FIG. 9, a virtual machine, a distributed computing system that includes multiple nodes of computing machines shown in FIG. 9, or any other suitable arrangement of computing devices.

By way of example, FIG. 9 shows a diagrammatic representation of a computing machine in the example form of a computer system 900 within which instructions 924 (e.g., software, source code, program code, expanded code, object code, assembly code, or machine code), which may be stored in a computer-readable medium for causing the machine to perform any one or more of the processes discussed herein may be executed. In some embodiments, the computing machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The structure of a computing machine described in FIG. 9 may correspond to any software, hardware, or combined components shown in FIGS. 1 and 2, including but not limited to, the knowledge management system 110, the data sources 120, the client device 130, the model serving system 145, and various engines, interfaces, terminals, and machines shown in FIG. 2. While FIG. 9 shows various hardware and software elements, each of the components described in FIGS. 1 and 2 may include additional or fewer elements.

By way of example, a computing machine may be a personal computer (PC), a tablet PC, a set-top box (STB), a personal digital assistant (PDA), a cellular telephone, a smartphone, a web appliance, a network router, an internet of things (IoT) device, a switch or bridge, or any machine capable of executing instructions 924 that specify actions to be taken by that machine. Further, while only a single machine is illustrated, the terms “machine” and “computer” may also be taken to include any collection of machines that individually or jointly execute instructions 924 to perform any one or more of the methodologies discussed herein.

The example computer system 900 includes one or more processors 902 such as a CPU (central processing unit), a GPU (graphics processing unit), a TPU (tensor processing unit), a DSP (digital signal processor), a system on a chip (SOC), a controller, a state equipment, an application-specific integrated circuit (ASIC), a field-programmable gate array (FPGA), or any combination of these. Parts of the computing system 900 may also include a memory 904 that stores computer code including instructions 924 that may cause the processors 902 to perform certain actions when the instructions are executed, directly or indirectly by the processors 902. Instructions can be any directions, commands, or orders that may be stored in different forms, such as equipment-readable instructions, programming instructions including source code, and other communication signals and orders. Instructions may be used in a general sense and are not limited to machine-readable codes. One or more steps in various processes described may be performed by passing through instructions to one or more multiply-accumulate (MAC) units of the processors.

One or more methods described herein improve the operation speed of the processor 902 and reduce the space required for the memory 904. For example, the database processing techniques and machine learning methods described herein reduce the complexity of the computation of the processors 902 by applying one or more novel techniques that simplify the steps in training, reaching convergence, and generating results of the processors 902. The algorithms described herein also reduce the size of the models and datasets to reduce the storage space requirement for memory 904.

The performance of certain operations may be distributed among more than one processor, not only residing within a single machine, but deployed across a number of machines. In some example embodiments, the one or more processors or processor-implemented modules may be located in a single geographic location (e.g., within a home environment, an office environment, or a server farm). In other example embodiments, one or more processors or processor-implemented modules may be distributed across a number of geographic locations. Even though the specification or the claims may refer to some processes to be performed by a processor, this may be construed to include a joint operation of multiple distributed processors. In some embodiments, a computer-readable medium comprises one or more computer-readable media that, individually, together, or distributedly, comprise instructions that, when executed by one or more processors, cause the one or more processors to perform, individually, together, or distributedly, the steps of the instructions stored on the one or more computer-readable media. Similarly, a processor comprises one or more processors or processing units that, individually, together, or distributedly, perform the steps of instructions stored on a computer-readable medium. In various embodiments, the discussion of one or more processors that carry out a process with multiple steps does not require any one of the processors to carry out all of the steps. For example, a processor A can carry out step A, a processor B can carry out step B using, for example, the result from the processor A, and a processor C can carry out step C, etc. The processors may work cooperatively in this type of situation such as in multiple processors of a system in a chip, in Cloud computing, or in distributed computing.

The computer system 900 may include a main memory 904, and a static memory 906, which are configured to communicate with each other via a bus 908. The computer system 900 may further include a graphics display unit 910 (e.g., a plasma display panel (PDP), a liquid crystal display (LCD), a projector, or a cathode ray tube (CRT)). The graphics display unit 910, controlled by the processor 902, displays a graphical user interface (GUI) to display one or more results and data generated by the processes described herein. The computer system 900 may also include an alphanumeric input device 912 (e.g., a keyboard), a cursor control device 914 (e.g., a mouse, a trackball, a joystick, a motion sensor, or other pointing instruments), a storage unit 916 (a hard drive, a solid-state drive, a hybrid drive, a memory disk, etc.), a signal generation device 918 (e.g., a speaker), and a network interface device 920, which also are configured to communicate via the bus 908.

The storage unit 916 includes a computer-readable medium 922 on which are stored instructions 924 embodying any one or more of the methodologies or functions described herein. The instructions 924 may also reside, completely or at least partially, within the main memory 904 or within the processor 902 (e.g., within a processor's cache memory) during execution thereof by the computer system 900, the main memory 904 and the processor 902 also constituting computer-readable media. The instructions 924 may be transmitted or received over a network 926 via the network interface device 920.

While computer-readable medium 922 is shown in an example embodiment to be a single medium, the term “computer-readable medium” should be taken to include a single medium or multiple media (e.g., a centralized or distributed database, or associated caches and servers) able to store instructions (e.g., instructions 924). The computer-readable medium may include any medium that is capable of storing instructions (e.g., instructions 924) for execution by the processors (e.g., processors 902) and that cause the processors to perform any one or more of the methodologies disclosed herein. The computer-readable medium may include, but not be limited to, data repositories in the form of solid-state memories, optical media, and magnetic media. The computer-readable medium does not include a transitory medium such as a propagating signal or a carrier wave.

### Additional Considerations

The foregoing description of the embodiments has been presented for the purpose of illustration; it is not intended to be exhaustive or to limit the patent rights to the precise forms disclosed. While particular embodiments and applications have been illustrated and described, it is to be understood that the invention is not limited to the precise construction and components disclosed herein and that various modifications, changes and variations which will be apparent to those skilled in the art may be made in the arrangement, operation and details of the method and apparatus disclosed herein without departing from the spirit and scope of the present disclosure. Persons skilled in the relevant art can appreciate that many modifications and variations are possible in light of the above disclosure. The term “steps” does not mandate or imply a particular order. For example, while this disclosure may describe a process that includes multiple steps sequentially with arrows present in a flowchart, the steps in the process do not need to be performed by the specific order claimed or described in the disclosure. Some steps may be performed before others even though the other steps are claimed or described first in this disclosure. Likewise, any use of (i), (ii), (iii), etc., or (a), (b), (c), etc. in the specification or in the claims, unless specified, is used to better enumerate items or steps and also does not mandate a particular order.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. In addition, the term “each” used in the specification and claims does not imply that every or all elements in a group need to fit the description associated with the term “each.” For example, “each member is associated with element A” does not imply that all members are associated with an element A. Instead, the term “each” only implies that a member (of some of the members), in a singular form, is associated with an element A. In claims, the use of a singular form of a noun may imply at least one element even though a plural form is not used.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights.

What is claimed is:

1. A computer-implemented method for improving retrieval speed of documents, the computer-implemented method comprising:
generating a plurality of prompts based on divisions of documents of unstructured text, each prompt relevant to a division of unstructured text, wherein at least one prompt is generated such that a corresponding division of unstructured text is a response to said at least one prompt;
generating prompt embeddings for the plurality of prompts, the plurality of prompts corresponding to the plurality of documents of unstructured text;
generating prompt-embedding clusters to group similar prompts from one or more documents of unstructured text;
receiving a query;
converting the query to one or more query embeddings;
identifying one or more prompts that are relevant to the query based on comparing the one or more query embeddings to the prompt embeddings; and
identifying one or more documents in one or more prompt-embedding clusters to which the one or more prompts that are relevant to the query belong.

2. The computer-implemented method of claim 1, wherein generating the plurality of prompts based on divisions of documents of unstructured text comprises:
segmenting the documents into paragraphs, sentences, or multi-paragraph sections; and
applying a language model to generate one or more prompts for each segment, wherein the generated prompts are contextually relevant to content of the corresponding segment.

3. The computer-implemented method of claim 1, wherein generating the prompt embeddings for the plurality of prompts comprises:
processing each prompt using an encoder-only language model to generate an embedding vector for each prompt.

4. The computer-implemented method of claim 1, wherein generating the prompt-embedding clusters to group similar prompts comprises:
applying a clustering algorithm to group embedding vectors based on similarity; and
recursively subdividing larger clusters into smaller clusters to refine grouping.

5. The computer-implemented method of claim 4, wherein the clustering algorithm is selected from a group consisting of k-means clustering, hierarchical clustering, density-based spatial clustering and spectral clustering.

6. The computer-implemented method of claim 1, wherein converting the query to one or more query embeddings comprises:
tokenizing the query into a sequence of text tokens;
processing the sequence of text tokens using an encoder-only language model to generate the query embeddings.

7. The computer-implemented method of claim 1, wherein identifying the one or more prompts relevant to the query comprises:
computing a similarity score between the query embeddings and the prompt embeddings using cosine similarity; and
selecting prompts with similarity scores above a predefined threshold.

8. The computer-implemented method of claim 1, wherein identifying the one or more documents in one or more prompt-embedding clusters to which the one or more prompts belong further comprises:
ranking the documents within the identified clusters based on relevance to the query embeddings; and
filtering the ranked documents to include only those exceeding a relevance threshold.

9. The computer-implemented method of claim 1, wherein the prompt-embedding clusters are associated with a metadata structure comprising:
identifiers of the documents from which the prompts were derived; and
a set of predefined topics or categories associated with each cluster.

10. The computer-implemented method of claim 1, further comprising:
generating a knowledge graph, wherein the prompts and entities extracted from the documents are represented as nodes and relationships between the prompts and the documents are represented as edges.

11. The computer-implemented method of claim 10, wherein identifying the one or more documents comprises:
identifying a node in the knowledge graph corresponding to the prompt-embedding relevant to the query; and
traversing edges from the identified node to related nodes based on predefined traversal criteria, the traversal criteria comprising edge relevance values or entity types.

12. The computer-implemented method of claim 11, wherein traversing the edges from the identified node to the related nodes comprises:
prioritizing traversal paths based on edge relevance scores;
aggregating information from the nodes encountered during traversal to generate a response to the query.

13. The computer-implemented method of claim 1, wherein at least a subset of the plurality of prompts generated are questions, each question being derived to elicit specific information from the corresponding division of text.

14. The computer-implemented method of claim 1, wherein the query is manually inputted by a user through an interface. or b. is automatically generated based on a topic or project context specified by the user, the topic or project context being associated with predefined keywords or parameters.

15. The computer-implemented method of claim 1, wherein the query is automatically generated based on a topic of a project specific by a user.

16. The computer-implemented method of claim 1, further comprising generating a response to the query, wherein generating the response to the query comprises:
retrieving relevant nodes and edges from a knowledge graph, the nodes and edges determined to be relevant to the query;
synthesizing retrieved information into an output format, the output format being text, a table, or a graphical representation; and
causing, at a user interface, to display an output to the user in the output format.

17. The computer-implemented method of claim 1, further comprising generating a response to the query, wherein the response comprises:
a textual summary generated using a transformer-based language model, the summary incorporating entities and relationships relevant to the query; and
a structured table summarizing numerical data retrieved from the documents containing the entities.

18. The computer-implemented method of claim 1, further comprising generating a response to the query, wherein generating the response to the query comprises:
creating an interactive visualization; and
enabling user interaction with the visualization to explore relationships between entities.

19. A system comprising:
one or more processors; and
memory storing instructions, wherein the instructions, when executed by the one or more processors, cause the one or more processors to perform steps comprising:
generating a plurality of prompts based on divisions of documents of unstructured text, each prompt relevant to a division of unstructured text, wherein at least one prompt is generated such that a corresponding division of unstructured text is a response to said at least one prompt;
generating prompt embeddings for the plurality of prompts, the plurality of prompts corresponding to the plurality of documents of unstructured text;
generating prompt-embedding clusters to group similar prompts from one or more documents of unstructured text;
receiving a query;
converting the query to one or more query embeddings;
identifying one or more prompts that are relevant to the query based on comparing the one or more query embeddings to the prompt embeddings; and
identifying one or more documents in one or more prompt-embedding clusters to which the one or more prompts that are relevant to the query belong.

20. A system comprising:
a data store storing a knowledge graph;
a computing system comprising one or more processors and memory, the memory storing instructions, wherein the instructions, when executed by the one or more processors, cause the one or more processors to perform steps comprising:
generating a plurality of prompts based on divisions of documents of unstructured text, each prompt relevant to a division of unstructured text, wherein at least one prompt is generated such that a corresponding division of unstructured text is a response to said at least one prompt;
generating prompt embeddings for the plurality of prompts, the plurality of prompts corresponding to the plurality of documents of unstructured text;
generating prompt-embedding clusters to group similar prompts from one or more documents of unstructured text;
receiving a query;
converting the query to one or more query embeddings;
identifying one or more prompts that are relevant to the query based on comparing the one or more query embeddings to the prompt embeddings; and
identifying one or more documents in one or more prompt-embedding clusters to which the one or more prompts that are relevant to the query belong; and
a graphical user interface of an application in communication with the computing system, the graphical user interface configured to generate a response to the query.
